(19) United States
(12) Patent Application Publication
(10) Pub. No.: US 2026/0072497 A1
(43) Pub. Date: Mar. 12, 2026

(54) ALIGNMENT BASED ON A REGION OF INTEREST

(71) Applicant: QUALCOMM Incorporated, San Diego, CA (US)

(72) Inventors: Roee HARDOON, Zichron Yaakov (IL); Eran PINHASOV, Zichron Yaakov (IL)

(21) Appl. No.: 18/830,432

(22) Filed: Sep. 10, 2024

(51) Int. Cl. G06F 3/01; G06T 3/14; G06T 5/20; G06T 5/70; G06T 7/33; G06T 7/73

(52) U.S. Cl. CPC G06F 3/013; G06T 3/14; G06T 5/20; G06T 5/70; G06T 7/337; G06T 7/74; G06T 2207/10024; G06T 2207/20221; G06T 2207/30196

(57) ABSTRACT

Systems and techniques are described herein for imaging. For instance, a method for imaging is provided. The method may include determining motion vectors based on a first image of a scene and a second image of the scene; obtaining an indication of a region of interest (ROI) of the first image; identifying, based on the indication of the ROI, a set of motion vectors associated with the ROI; and aligning the ROI of the first image with a corresponding region of the second image based on the set of motion vectors to generate aligned first image data.

### TECHNICAL FIELD

The present disclosure generally relates to imaging. For example, aspects of the present disclosure include systems and techniques for aligning images based on a region of interest.

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can allow users to experience XR environments by overlaying virtual content onto a user's view of a real-world environment. For example, an XR head-mounted device (HMD) may include a display that allows a user to view the user's real-world environment through a display of the HMD (e.g., a transparent display). The XR HMD may display virtual content at the display in the user's field of view overlaying the user's view of their real-world environment. Such an implementation may be referred to as “see-through” XR. As another example, an XR HMD may include a scene-facing camera that may capture images of the user's real-world environment. The XR HMD may modify or augment the images (e.g., adding virtual content) and display the modified images to the user. Such an implementation may be referred to as “pass through” XR or as “video see through (VST).” The user can generally change their view of the environment interactively, for example by tilting or moving the XR HMD.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for imaging. According to at least one example, a method is provided for imaging. The method includes: determining motion vectors based on a first image of a scene and a second image of the scene; obtaining an indication of a region of interest (ROI) of the first image; identifying, based on the indication of the ROI, a set of motion vectors associated with the ROI; and aligning the ROI of the first image with a corresponding region of the second image based on the set of motion vectors to generate aligned first image data.

In another example, an apparatus for imaging is provided that includes at least one memory and at least one processor (e.g., configured in circuitry) coupled to the at least one memory. The at least one processor configured to: determine motion vectors based on a first image of a scene and a second image of the scene; obtain an indication of a region of interest (ROI) of the first image; identify, based on the indication of the ROI, a set of motion vectors associated with the ROI; and align the ROI of the first image with a corresponding region of the second image based on the set of motion vectors to generate aligned first image data.

In another example, a non-transitory computer-readable medium is provided that has stored thereon instructions that, when executed by one or more processors, cause the one or more processors to: determine motion vectors based on a first image of a scene and a second image of the scene; obtain an indication of a region of interest (ROI) of the first image; identify, based on the indication of the ROI, a set of motion vectors associated with the ROI; and align the ROI of the first image with a corresponding region of the second image based on the set of motion vectors to generate aligned first image data.

In another example, an apparatus for imaging is provided. The apparatus includes: means for determining motion vectors based on a first image of a scene and a second image of the scene; means for obtaining an indication of a region of interest (ROI) of the first image; means for identifying, based on the indication of the ROI, a set of motion vectors associated with the ROI; and means for aligning the ROI of the first image with a corresponding region of the second image based on the set of motion vectors to generate aligned first image data.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IOT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example extended-reality (XR) system, according to aspects of the disclosure;

FIG. 2A is a diagram illustrating an example extended-reality (XR) system, according to aspects of the disclosure;

FIG. 2B is a diagram of an example apparatus for capturing facial images of a user;

FIG. 3 includes example facial images that may be used for gaze tracking;

FIG. 4 is a block diagram illustrating an architecture of an example extended reality (XR) system, in accordance with some aspects of the disclosure;

FIG. 5 is a diagram illustrating an example of an image including a keypoint according to various aspects of the present disclosure;

FIG. 6 is a block diagram illustrating an example system for transforming an image based on a region of interest (ROI), according to various aspects of the present disclosure;

FIG. 7 is a block diagram of an example system for transforming an image based on a region of interest (ROI), according to various aspects of the present disclosure;

FIG. 8 includes an example image 800 including representations of motion vectors, according to various aspects of the present disclosure;

FIG. 9 includes an example image including motion vectors and a bounding box, according to various aspects of the present disclosure;

FIG. 10 is a block diagram of an example system for transforming an image based on a region of interest (ROI), according to various aspects of the present disclosure;

FIG. 11 is a flow diagram illustrating an example process for imaging, in accordance with aspects of the present disclosure;

FIG. 12 is a block diagram illustrating an example of a deep learning neural network that can be used to perform various tasks, according to some aspects of the disclosed technology;

FIG. 13 is a block diagram illustrating an example of a convolutional neural network (CNN), according to various aspects of the present disclosure; and

FIG. 14 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs) (which may also be referred to as a head-mounted devices), XR glasses (e.g., AR glasses, MR glasses, etc.) (also referred to as smart or network-connected glasses), among others. In some cases, XR glasses are an example of an HMD. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects and devices in the physical world. For example, an XR system can use tracking information to calculate the relative pose of devices, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user may be used to represent the user in a virtual environment. A virtual representation of a user is also referred to herein as an avatar. An avatar representing a user may mimic an appearance, movement, mannerisms, and/or other features of the user. In some examples, the user may desire that the avatar representing the person in the virtual environment appear as a digital twin of the user. In any virtual environment, it is important for an XR system to efficiently generate high-quality avatars (e.g., realistically representing the appearance, movement, etc. of the person) in a low-latency manner. It can also be important for the XR system to render audio in an effective manner to enhance the XR experience.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

Some XR devices (e.g., HMDs) may implement video see through (VST). In VST, an XR HMD may capture images of a field of view of a user and display the images to the user as if the user were viewing the field of view directly. While displaying the images of the field of view, the XR HMD may alter or augment the images providing the user with an altered or augmented view of the environment of the user (e.g., providing the user with an XR experience).

Temporal filtering may be used to reduce noise in image data. For example, a number of images may be captured over a time duration (e.g., frames of video data captured at a frame rate). For instance, a first image may be captured at a first time and a second image may be captured at a second time. The first image may be averaged with the second image and the resulting image may be used in place of the first image. The resulting image may have reduced noise compared with the first image because the resulting image is based on two images, each with different noise and the different noise may average out between the two images.

Alignment between images improves temporal filtering. For example, if an object in images moves between the times the images are captured (e.g., local motion), temporal filtering may blur the object. If a camera that captured the images moves between the times the images are captured (e.g., global motion), temporal filtering may blur the whole image. Aligning images may involve determining a relationship between pixels of a first image and pixels of a second image. For example, a group of pixels of a first image may represent a feature (e.g., a visually distinct object in a scene). A group of pixels of a second image may also represent the feature. Alignment may involve determining a transformation between the group of pixels of the first image and the group of pixels of the second image. The transformation can then be applied to the first image to cause the first image to be aligned with the second image. Then, the aligned first image and the second image can be temporally filtered.

Other tasks may use aligned images. For example, images from separate cameras may be aligned, for example, to stitch the images together, for instance to generate a composite image. As another example, aligning a first image from a first camera to a second image from the first camera, or from a second camera, may be used to adjust colors of the first image and/or the second image. As yet another example, aligning a first image from a first camera to a second image from a second camera may allow reprojection of one of the images and/or for solving a three-dimensional problem between the first and second cameras. The performance of any of these tasks, or other tasks, may be improved by improving an alignment between images. The improvements to alignment may be, or may include, an improvement to accuracy of the alignment, an increase in the speed of the alignment process, and/or a decrease in the power consumption of the alignment process.

Some devices (e.g., XR devices) may determine a gaze of a viewer (e.g., where the viewer is gazing). For example, some devices may capture images of eyes of a user and determine where the user is gazing based on an orientation of the eyes of the user. Further, some devices may determine where the user is gazing with relation to displayed images. For example, in instances an XR HMD may determine where a user is gazing relative to images displayed at a display of the XR HMD.

Systems, apparatuses, methods (also referred to as processes), and computer-readable media (collectively referred to herein as “systems and techniques”) are described herein for image alignment based on a region of interest. For example, the systems and techniques may align images based on a region of interest (ROI) within the images. By aligning the images based on the ROI, the systems and techniques may improve the performance downstream tasks. For example, aligning images may improve temporal filtering, fusing of images, determining a spatial-alignment transform. Further, by aligning the images based on the ROI the systems and techniques may conserve computational resources (e.g., computational time and power) as compared with techniques that align images based on an entirety of the images.

For example, the systems and techniques may obtain a first image of a scene and a second image of the scene. The systems and techniques may determine features of the first image and corresponding features of the second image. Then, the systems and techniques may determine motion vectors between the features of the first image and the features of the second image. The motion vectors may indicate how the features changed position from the first image to the second image. The features may, or may not, move uniformly between the two images. For example, an object in the scene may move (local motion). As another example, if a camera that captured the two images moves (global motion), features at different depths within the scene may move differently.

The systems and techniques may determine a region of interest (ROI) of a first image. For example, the systems and techniques may capture an image of eyes of a user and determine a gaze of the user relative to the first image. The systems and techniques may determine the ROI based on the gaze of the user relative to the first image. For example, the systems and techniques may determine a region within the first image that user is gazing at.

Then the systems and techniques may screen the motion vectors based on the ROI. For example, the systems and techniques may identify ROI motion vectors that are related to the ROI (e.g., within the ROI in the first image). In some aspects, the systems and techniques may further identify non-ROI motion vectors that are related to a peripheral region of the first image (e.g., not within the ROI in the first image). In the present disclosure, the term peripheral may refer to a region that is separate from an ROI. A peripheral region may be proximate to, surrounding, abutting, offset, or spaced apart an ROI.

The systems and techniques may determine a motion model based on the ROI motion vectors. For example, the systems and techniques may use a random sample consensus (RANSAC) technique to generate a motion model based on the ROI motion vectors. The motion model may be a homography transform or an affine transform. Additionally or alternatively, the systems and techniques may remove outliers from the ROI motion vectors, for example, using the RANSAC technique.

The systems and techniques may use the motion model to transform at least the ROI of the first image. In some aspects, the systems and techniques may transform the whole first image based on the motion model. In other aspects, the systems and techniques may transform the ROI. Transforming the ROI (and/or the first image), based on the transformation, may align the ROI (and/or the first image) with the second image.

In some aspects, the systems and techniques may modify the second image based on the transformed first image. For example, the systems and techniques may perform temporal filtering using the transformed first image and the second image. For example, the systems and techniques may implement a motion-compensated temporal filter (MCTF) technique, or a multi-frame noise reduction (MFNR) technique. As another example, the systems and techniques may fuse the transformed first image and the second image. As yet another example, the systems and techniques may stitch the transformed first image with the second image. As yet another example, the systems and techniques may adjust colors of the first and/or the second image.

In some aspects, the systems and techniques may also determine a non-ROI motion model based on the non-ROI motion vectors. The systems and techniques may transform the ROI of the first image using the motion model (e.g., the motion model described above). Further the systems and techniques may transform a peripheral portion of the first image based on the non-ROI motion model. The systems and techniques may then modify the second image with the transformed first image.

Additionally or alternatively, the systems and techniques may transform the ROI of the first image using the motion model, then modify an ROI portion of the second image using the transformed first image. To do this, the systems and techniques may identify an ROI portion of the second image, for example, based on the ROI portion of the first image and/or based on ROI motion vectors between the first image and the second image. Additionally, the systems and techniques may transform the non-ROI portion of the first image using the non-ROI motion model then modify the non-ROI portion of the second image using the transformed non-ROI portion of the first image. To do this, the systems and techniques may identify a peripheral region of the second image, for example, based on the peripheral region of the first image and/or based on motion vectors between the first image and the second image. Then, the systems and techniques may combine the modified ROI with the modified peripheral region.

Additionally or alternatively, the systems and techniques may obtain low-resolution instances of the first and second images and transform a peripheral portion of the low-resolution first image based on the non-ROI motion model. The systems and techniques may then modify (e.g., temporally filter) a peripheral portion of the low-resolution second image with the transformed peripheral portion of the low-resolution first image. The systems and techniques may combine the modified ROI with the modified low-resolution peripheral region.

Various aspects of the application will be described with respect to the figures below.

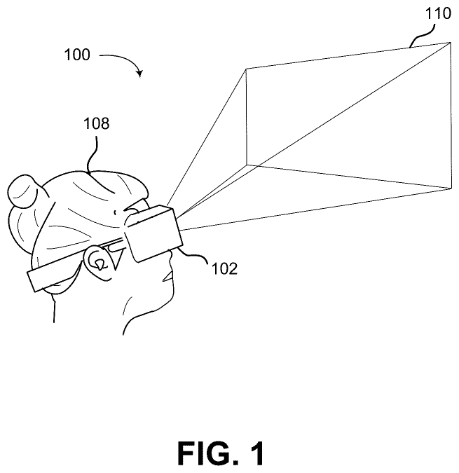

FIG. 1 is a diagram illustrating an example extended-reality (XR) system 100, according to aspects of the disclosure. As shown, XR system 100 includes an XR device 102. XR device 102 may implement, as examples, image-capture, object-detection, gaze-tracking, view-tracking, localization, computational and/or display aspects of extended reality, including virtual reality (VR), augmented reality (AR), and/or mixed reality (MR). For example, XR device 102 may include one or more scene-facing cameras that may capture images of a scene in which user 108 uses XR device 102. XR device 102 may detect objects in the scene based on the images of the scene. Further, XR device 102 may include one or more user-facing cameras that may capture images of eyes of user 108. XR device 102 may determine a gaze of user 108 based on the images of user 108. XR device 102 may determine an object of interest in the scene based on the gaze of user 108. XR device 102 may obtain and/or render information (e.g., text, images, and/or video based on the object of interest). XR device 102 may display the information to a user 108 (e.g., within a field of view 110 of user 108).

XR device 102 may display the information to be viewed by a user 108 in field of view 110 of user 108. For example, in a “see-through” configuration, XR device 102 may include a transparent surface (e.g., optical glass) such that information may be displayed on (e.g., by being projected onto) the transparent surface to overlay the information onto the scene as viewed through the transparent surface. In a “pass-through” configuration or a “video see-through” configuration, XR device 102 may include a scene-facing camera that may capture images of the scene of user 108. XR device 102 may display images or video of the scene, as captured by the scene-facing camera, and information overlaid on the images or video of the scene.

In various examples, XR device 102 may be, or may include, a head-mounted device (HMD), a virtual reality headset, and/or smart glasses. XR device 102 may include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, display, and/or smart glass).

In some aspects, XR device 102 may be, or may include, two or more devices. For example, XR device 102 may include a display device and a processing device. The display device may generate data, such as image data (e.g., from user-facing cameras and/or scene-facing cameras) and/or motion data (from an inertial measurement unit (IMU)). The display device may provide the data to the processing device, for example, through a wireless connection. The processing device may process the data and/or other data. Further, the processing unit may generate data to be displayed at the display device. The processing device may provide the generated data to the display device, for example, through the wireless connection.

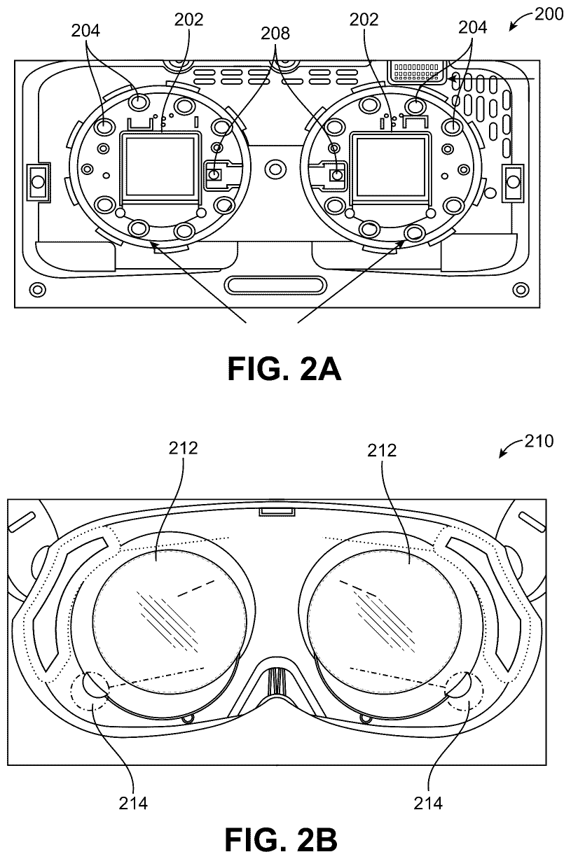

FIG. 2A is a diagram of an example apparatus 200 for capturing facial images of a user. Apparatus 200 may be an HMD, for example, a XR device. Apparatus 200 includes two displays 202. When apparatus 200 is worn by a user, displays 202 may be proximate to eyes of the user. Additionally, apparatus 200 includes cameras 208, which are positioned such that when apparatus 200 is worn by a user, cameras 208 are positioned and angled to capture images of eyes of the user. Apparatus 200 also includes light sources 204, which are positioned such that when apparatus 200 is worn by a user, light sources 204 are positioned to illuminate the eyes of the user.

In the present disclosure, references to light and illumination include electromagnetic radiation of any wavelength, including as examples, ultraviolet UV, visible, near infrared (NIR), and infrared (IR). Examples of light sources include light-emitting diodes (LEDs), edge-emitting lasers (EELs), and vertical-cavity surface-emitting lasers (VCSELs).

In the present disclosure, references to “eyes” should be understood to apply to one eye or two eyes. For example, in some aspects, a device may capture an images of one eye of a user. Additionally, references to capturing “images of eyes,” “eye images,” “facial images” “images of eyes and/or face,” and like terms, should be understood to apply to capturing images of eyes and/or other portions of a user's face, such as eyelids, eyebrows, brow, nose, checks, lips, mouth, etc.

FIG. 2B is a diagram of an example apparatus 210 for capturing facial images of a user. Apparatus 210 includes lenses 212 (which may be referred to as “pancake lenses”). A user may view a display through lenses 212. For example, lenses 212 may focus light from the display to eyes of the user. Additionally, apparatus 210 includes cameras 214 which may capture images of eyes of the user. Apparatus 210 may also include light sources (not labelled in FIG. 2B) that may illuminate eyes of the user.

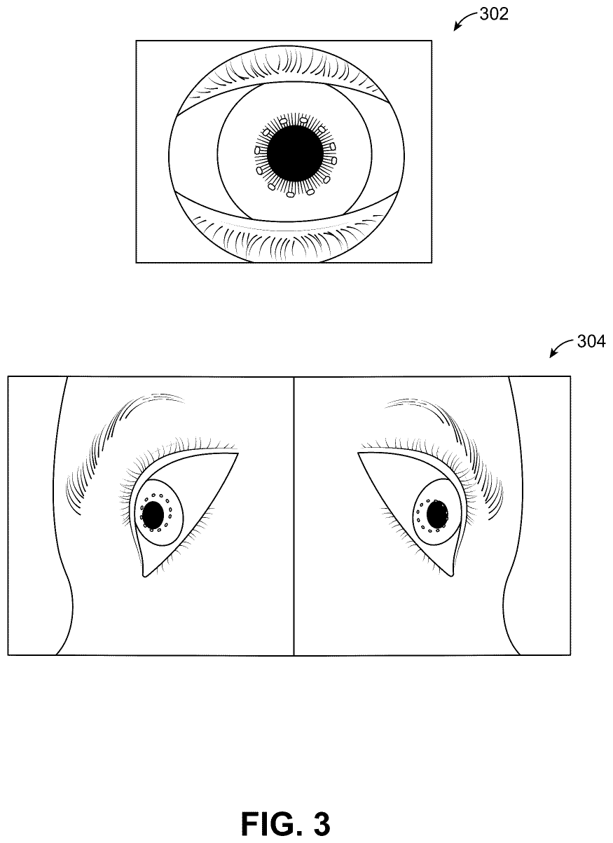

FIG. 3 includes example facial images (e.g., image 302 and images 304) that may be used for gaze tracking. Gaze tracking may involve illuminating an eye with a pattern and comparing a pupil of the eye to the pattern. Additionally or alternatively, gaze tracking may involve resolving a shape of a ring and a pupil contour and using centers (e.g., a center of a pupil and a center of a reflected ring of illumination) for triangulation. Image 302 includes an image of an eye captured from directly in front of the eye. Images 304 includes images of an eye captured from the side, for example, by cameras such as cameras 214 of FIG. 2B.

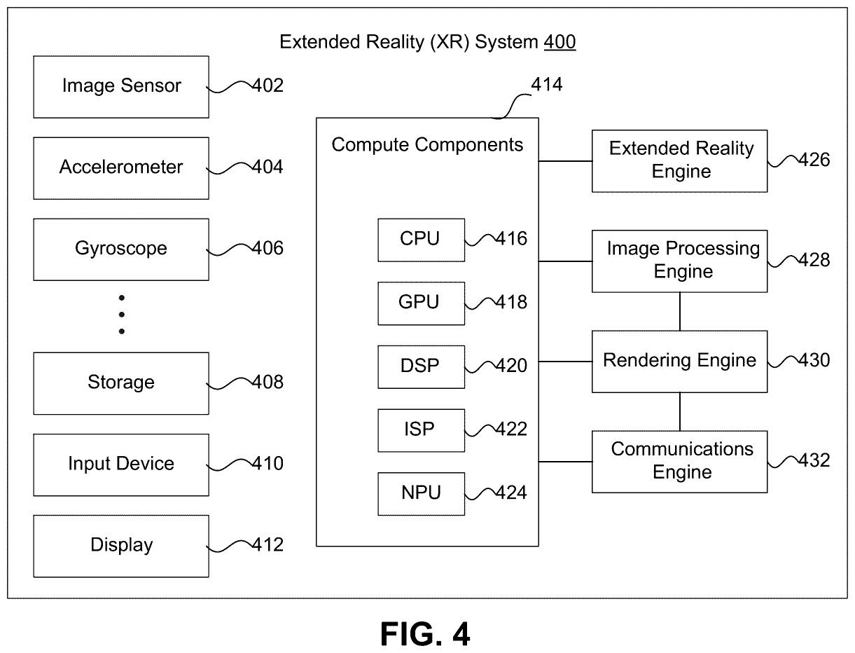

FIG. 4 is a diagram illustrating an architecture of an example extended reality (XR) system 400, in accordance with some aspects of the disclosure. XR system 400 may execute XR applications and implement XR operations.

In this illustrative example, XR system 400 includes one or more image sensors 402, an accelerometer 404, a gyroscope 406, storage 408, an input device 410, a display 412, Compute components 414, an XR engine 426, an image processing engine 428, a rendering engine 430, and a communications engine 432. It should be noted that the components 402-432 shown in FIG. 4 are non-limiting examples provided for illustrative and explanation purposes, and other examples may include more, fewer, or different components than those shown in FIG. 4. For example, in some cases, XR system 400 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 4. While various components of XR system 400, such as image sensor 402, may be referenced in the singular form herein, it should be understood that XR system 400 may include multiple of any component discussed herein (e.g., multiple image sensors 402).

Display 412 may be, or may include, a glass, a screen, a lens, a projector, and/or other display mechanism that allows a user to see the real-world environment and also allows XR content to be overlaid, overlapped, blended with, or otherwise displayed thereon.

XR system 400 may include, or may be in communication with, (wired or wirelessly) an input device 410. Input device 410 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 402 may capture images that may be processed for interpreting gesture commands.

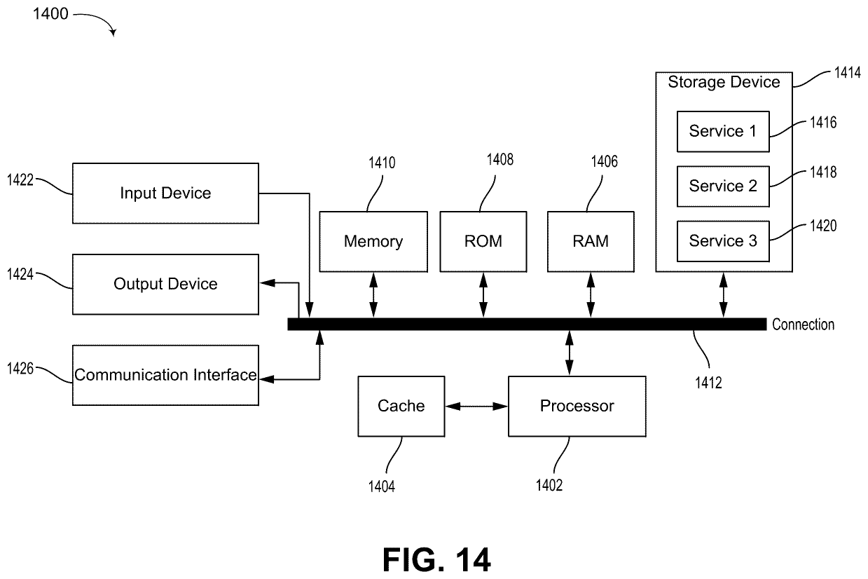

XR system 400 may also communicate with one or more other electronic devices (wired or wirelessly). For example, communications engine 432 may be configured to manage connections and communicate with one or more electronic devices. In some cases, communications engine 432 may correspond to communication interface 1426 of FIG. 14.

In some implementations, image sensors 402, accelerometer 404, gyroscope 406, storage 408, display 412, compute components 414, XR engine 426, image processing engine 428, and rendering engine 430 may be part of the same computing device. For example, in some cases, image sensors 402, accelerometer 404, gyroscope 406, storage 408, display 412, compute components 414, XR engine 426, image processing engine 428, and rendering engine 430 may be integrated into an HMD, extended reality glasses, smartphone, laptop, tablet computer, gaming system, and/or any other computing device. However, in some implementations, image sensors 402, accelerometer 404, gyroscope 406, storage 408, display 412, compute components 414, XR engine 426, image processing engine 428, and rendering engine 430 may be part of two or more separate computing devices. For instance, in some cases, some of the components 402-432 may be part of, or implemented by, one computing device and the remaining components may be part of, or implemented by, one or more other computing devices. For example, such as in a split perception XR system, XR system 400 may include a first device (e.g., an HMD), including display 412, image sensor 402, accelerometer 404, gyroscope 406, and/or one or more compute components 414. XR system 400 may also include a second device including additional compute components 414 (e.g., implementing XR engine 426, image processing engine 428, rendering engine 430, and/or communications engine 432). In such an example, the second device may generate virtual content based on information or data (e.g., images, sensor data such as measurements from accelerometer 404 and gyroscope 406) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 408 may be any storage device(s) for storing data. Moreover, storage 408 may store data from any of the components of XR system 400. For example, storage 408 may store data from image sensor 402 (e.g., image or video data), data from accelerometer 404 (e.g., measurements), data from gyroscope 406 (e.g., measurements), data from compute components 414 (e.g., processing parameters, preferences, virtual content, rendering content, scene maps, tracking and localization data, object detection data, privacy data, XR application data, face recognition data, occlusion data, etc.), data from XR engine 426, data from image processing engine 428, and/or data from rendering engine 430 (e.g., output frames). In some examples, storage 408 may include a buffer for storing frames for processing by compute components 414.

Compute components 414 may be, or may include, a central processing unit (CPU) 416, a graphics processing unit (GPU) 418, a digital signal processor (DSP) 420, an image signal processor (ISP) 422, a neural processing unit (NPU) 424, which may implement one or more trained neural networks, and/or other processors. Compute components 414 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 414 may implement (e.g., control, operate, etc.) XR engine 426, image processing engine 428, and rendering engine 430. In other examples, compute components 414 may also implement one or more other processing engines.

Image sensor 402 may include any image and/or video sensors or capturing devices. In some examples, image sensor 402 may be part of a multiple-camera assembly, such as a dual-camera assembly. Image sensor 402 may capture image and/or video content (e.g., raw image and/or video data), which may then be processed by compute components 414, XR engine 426, image processing engine 428, and/or rendering engine 430 as described herein.

In some examples, image sensor 402 may capture image data and may generate images (also referred to as frames) based on the image data and/or may provide the image data or frames to XR engine 426, image processing engine 428, and/or rendering engine 430 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 402 (and/or other camera of XR system 400) may be configured to also capture depth information. For example, in some implementations, image sensor 402 (and/or other camera) may include an RGB-depth (RGB-D) camera. In some cases, XR system 400 may include one or more depth sensors (not shown) that are separate from image sensor 402 (and/or other camera) and that may capture depth information. For instance, such a depth sensor may obtain depth information independently from image sensor 402. In some examples, a depth sensor may be physically installed in the same general location or position as image sensor 402 but may operate at a different frequency or frame rate from image sensor 402. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 400 may also include other sensors in its one or more sensors. The one or more sensors may include one or more accelerometers (e.g., accelerometer 404), one or more gyroscopes (e.g., gyroscope 406), and/or other sensors. The one or more sensors may provide velocity, orientation, and/or other position-related information to compute components 414. For example, accelerometer 404 may detect acceleration by XR system 400 and may generate acceleration measurements based on the detected acceleration. In some cases, accelerometer 404 may provide one or more translational vectors (e.g., up/down, left/right, forward/back) that may be used for determining a position or pose of XR system 400. Gyroscope 406 may detect and measure the orientation and angular velocity of XR system 400. For example, gyroscope 406 may be used to measure the pitch, roll, and yaw of XR system 400. In some cases, gyroscope 406 may provide one or more rotational vectors (e.g., pitch, yaw, roll). In some examples, image sensor 402 and/or XR engine 426 may use measurements obtained by accelerometer 404 (e.g., one or more translational vectors) and/or gyroscope 406 (e.g., one or more rotational vectors) to calculate the pose of XR system 400. As previously noted, in other examples, XR system 400 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 400, using a combination of one or more accelerometers, one or more gyroscopes, and/or one or more magnetometers. In some examples, the one or more sensors may output measured information associated with the capture of an image captured by image sensor 402 (and/or other camera of XR system 400) and/or depth information obtained using one or more depth sensors of XR system 400.

The output of one or more sensors (e.g., accelerometer 404, gyroscope 406, one or more IMUs, and/or other sensors) can be used by XR engine 426 to determine a pose of XR system 400 (also referred to as the head pose) and/or the pose of image sensor 402 (or other camera of XR system 400). In some cases, the pose of XR system 400 and the pose of image sensor 402 (or other camera) can be the same. The pose of image sensor 402 refers to the position and orientation of image sensor 402 relative to a frame of reference (e.g., with respect to a field of view 110 of FIG. 1). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees of Freedom (3DoF), which refers to the three angular components (e.g. roll, pitch, and yaw).

In some cases, a device tracker (not shown) can use the measurements from the one or more sensors and image data from image sensor 402 to track a pose (e.g., a 6DoF pose) of XR system 400. For example, the device tracker can fuse visual data (e.g., using a visual tracking solution) from the image data with inertial data from the measurements to determine a position and motion of XR system 400 relative to the physical world (e.g., the scene) and a map of the physical world. As described below, in some examples, when tracking the pose of XR system 400, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 400 within the scene and the 3D map of the scene, etc. The 3D map can provide a digital representation of a scene in the real/physical world. In some examples, the 3D map can anchor position-based objects and/or content to real-world coordinates and/or objects. XR system 400 can use a mapped scene (e.g., a scene in the physical world represented by, and/or associated with, a 3D map) to merge the physical and virtual worlds and/or merge virtual content or objects with the physical environment.

In some aspects, the pose of image sensor 402 and/or XR system 400 as a whole can be determined and/or tracked by compute components 414 using a visual tracking solution based on images captured by image sensor 402 (and/or other camera of XR system 400). For instance, in some examples, compute components 414 can perform tracking using computer vision-based tracking, model-based tracking, and/or simultaneous localization and mapping (SLAM) techniques. For instance, compute components 414 can perform SLAM or can be in communication (wired or wireless) with a SLAM system (not shown). SLAM refers to a class of techniques where a map of an environment (e.g., a map of an environment being modeled by XR system 400) is created while simultaneously tracking the pose of a camera (e.g., image sensor 402) and/or XR system 400 relative to that map. The map can be referred to as a SLAM map and can be three-dimensional (3D). The SLAM techniques can be performed using color or grayscale image data captured by image sensor 402 (and/or other camera of XR system 400) and can be used to generate estimates of 6DoF pose measurements of image sensor 402 and/or XR system 400. Such a SLAM technique configured to perform 6DoF tracking can be referred to as 6DoF SLAM. In some cases, the output of the one or more sensors (e.g., accelerometer 404, gyroscope 406, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 402 (and/or other camera) to the SLAM map. For example, 6DoF SLAM can use feature point associations from an input image to determine the pose (position and orientation) of the image sensor 402 and/or XR system 400 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 402 and/or the XR system 400 can be determined by projecting features from the 3D SLAM map into an image or video frame and updating the camera pose from verified 2D-3D correspondences.

In one illustrative example, the compute components 414 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 414 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 400 can also track the hand and/or fingers of the user to allow the user to interact with and/or control virtual content in a virtual environment. For example, the XR system 400 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

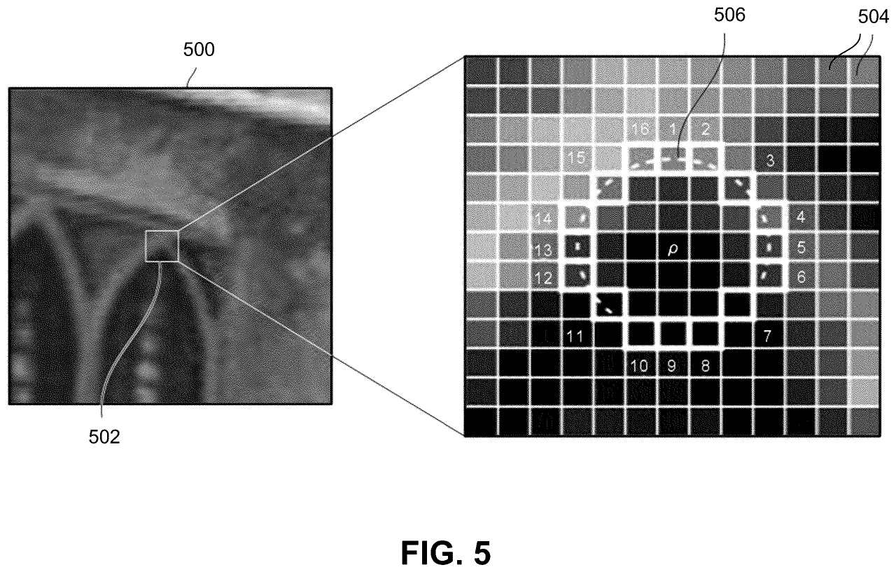

FIG. 5 is a diagram illustrating an example of an image 500 including a keypoint p according to various aspects of the present disclosure. Keypoint p is surrounded by a window 502 of pixels 504 in the image 500. Keypoint p may be selected such that keypoint p can be matched between images. For example, Keypoint p may be visually distinct in image 500. Keypoint p may be, as an example, a corner point on an object. In the art a keypoint may be alternatively referred to as a feature, a visual feature, a point of interest or a key point. An example keypoint-detection method is described with regard to FIG. 5. In particular, FIG. 5 illustrates the Features from Accelerated Segment Test (FAST) technique (Machine Learning for High-Speed Corner Detection, Edward Rosten & Tom Drummond, ECCV 2006: Computer Vision-ECCV 2006 pp 430-443, Part of the Lecture Notes in Computer Science book series (LNIP, volume 3951)). In the FAST method, a pixel under test (e.g., pixel p) with intensity Ip may be identified as an interest point. A circle 506 of sixteen pixels (pixels 1-16) around the pixel under test p (e.g., a Bresenham circle of radius 3) may then be identified. The pixel under test p may be considered a keypoint if there exists a set of n contiguous pixels in circle 506 of sixteen pixels that are all brighter than Ip+t, or all darker than Ip−1, where t is a threshold value and n is configurable. In this example, n may be twelve. For example, the intensity of pixels 1, 5, 9, and 13 of the circle may be compared with Ip. If at least three of the four pixels do not satisfy the threshold criteria, the pixel p is not considered an interest point. As can be seen in FIG. 5, at least three of the four pixels satisfy the threshold criteria. Therefore, all sixteen pixels may be compared to pixel p to determine if twelve contiguous pixels meet the threshold criteria. This process may be repeated for each of pixels 504 in the image 500 to identify the corner points corresponding to keypoint p in image 500.

Although FIG. 5 illustrates a FAST keypoint-identifying method, it should be understood that the present disclosure is applicable to any keypoint-identifying method. Examples of keypoint-identifying methods include speeded-up robust features (SURF), scale-invariant feature transform (SIFT), binary robust independent elementary feature (BRIEF), oriented FAST and rotated BRIEF (ORB), and Harris corner point.

As indicated above, a keypoint p represents a feature of an image 500 that may be matched between multiple images of a scene (e.g., captured from different viewing angles and/or with different intrinsic camera parameters). For example, various cross-correlation or optical flow methods may match features (keypoints) across multiple images. In some examples, each feature may further include a feature descriptor that assists with the matching process. A feature descriptor may summarize, in vector format (e.g., of constant length) one or more characteristics of pixels 504 of window 502. For example, the feature descriptor may correspond to the intensity of pixels 504 of window 502. In general, feature descriptors are independent of the positions of keypoint p, robust against image transformations, lighting of the scene, and/or weather of the scene, and scale independently. Thus, keypoints with feature descriptors may be independently re-detected in each image frame and then subjected to a keypoint matching/tracking procedure. For example, the keypoints in two different images with matching descriptors and the smallest distance between them may be considered to be matching keypoints. Examples of feature-descriptor methods may include, but are not limited to, ORB, SURF, and BRIEF.

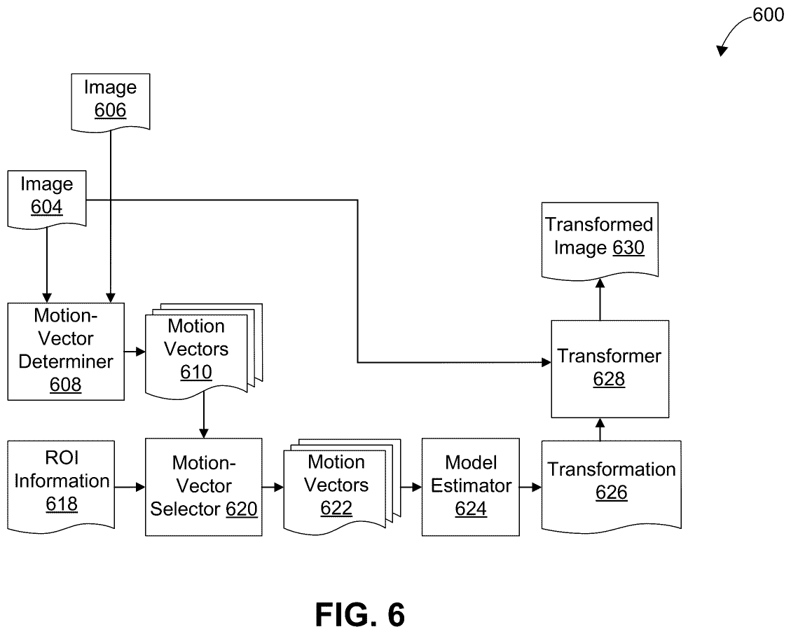

As noted previously, systems and techniques are described herein for performing image alignment based on a region of interest. FIG. 6 is a block diagram illustrating an example system 600 for transforming an image based on a region of interest (ROI), according to various aspects of the present disclosure. For example, system 600 may obtain image data 604 (which may be alternatively referred to as “image 604”) and image data 606 (which may be alternatively referred to as “image 606”). A motion-vector determiner 608 may determine motion vectors 610 based on image data 604 and image data 606. System 600 may obtain ROI information 618 and a motion-vector selector 620 may determine motion vectors 622, which may be a subset of motion vectors 610, based on ROI information 618. A model estimator 624 may generate a transformation 626 based on motion vectors 622 and a transformer 628 may transform image data 604 to generate transformed image data 630 (which may be alternatively referred to as “transformed image 630”) based on transformation 626.

Image data 604 and image data 606 may represent a scene (e.g., the same scene). Image data 604 and image data 606 may be different. For example, image data 604 and image data 606 may be captured at different times and/or from different positions. In some aspects, image data 604 and image data 606 may be captured by the same camera at different times. For example, image data 604 and image data 606 may be consecutive frames of video data. In some aspects, image data 604 and image data 606 may be captured by different cameras, for example, from different positions. In such cases, image data 604 and image data 606 may be captured at substantially the same time, or at different times.

Motion-vector determiner 608 may determine motion vectors 610 based on image data 604 and image data 606. For example, motion-vector determiner 608 may determine features of image data 604 and corresponding features of image data 606. Then, motion-vector determiner 608 may determine motion vectors 610 between the features of image data 604 and the corresponding features of image data 606. Motion-vector determiner 608 may be, or may include, vectors describing how positions of features are different between image data 604 and image data 606. For example, motion-vector determiner 608 may describe how features moved between image data 604 and image data 606 (e.g., if image data 606 was captured after image data 604 was captured).

The features may, or may not, change uniformly between image data 604 and image data 606. For example, an object in the scene may move (local motion) between when image data 604 is captured and when image data 606 is captured. As another example, if a camera that captured image data 604 and image data 606 moves (global motion), features at different depths within the scene may move differently. As yet another example, if a first camera captured image data 604 and a second camera captured image data 606, features in image data 604 and image data 606 may be different based on the position and/or pointing direction of the first and second cameras.

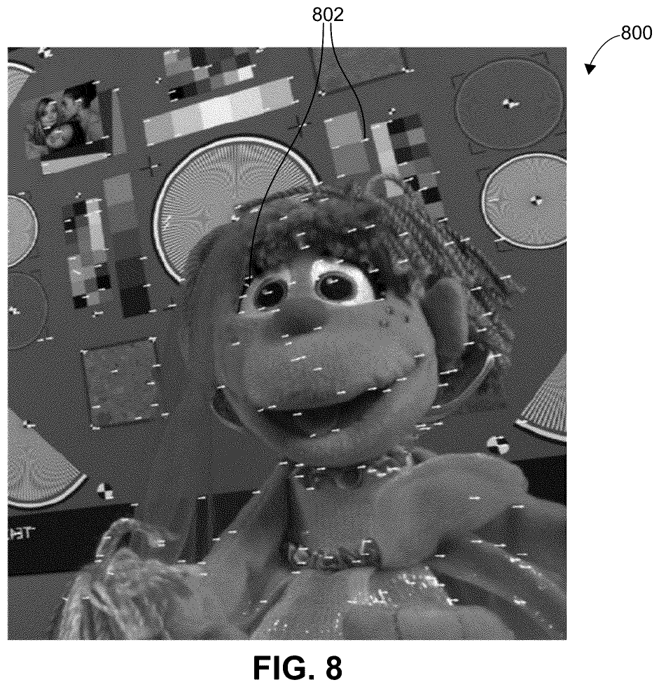

FIG. 8 includes an example image 800 including representations of motion vectors 802, according to various aspects of the present disclosure. Motion vectors 802 are represented in image 800 as white arrows indicating a change in a position of features between a first image and a second image.

Returning to FIG. 6, ROI information 618 may be, or may include, an indication of an ROI relative to image data 604 and/or image data 606. In some aspects, ROI information 618 may be, or may include, a bounding box indicating pixels of image data 604 and/or image data 606 that define the ROI. The bounding box may have any shape, for example, rectangular, ovular, or a shape based on an object in image data 604 and/or image data 606 (e.g., as determined by an object detector or edge detector). In some aspects, ROI information 618 may be based on a gaze of a user. In some aspects, ROI information 618 may be determined based on another input from a user, such as a touch, for example, at a touch screen. Additionally or alternatively, ROI information 618 may be determined based on a computer-vision process, such as a saliency-based process.

Motion-vector selector 620 may determine motion vectors 622 from among motion vectors 610 based on ROI information 618. Motion vectors 622 may be a subset of motion vectors 610. Motion-vector selector 620 may select motion vectors 622 from among motion vectors 610. Motion vectors 622 may be the motion vectors of motion vectors 610 that are within an ROI defined by ROI information 618.

In some aspects, in addition to determining motion vectors 622 that are within the ROI defined by ROI information 618, motion vectors 622 may determine a set of motion vectors that are not within the ROI. For example, motion-vector selector 620 may determine a set of in-ROI motion vectors and a set of out-of-ROI motion vectors. The out-of-ROI motion vectors may be the motion vectors of motion vectors 610 that are not included in motion vectors 622.

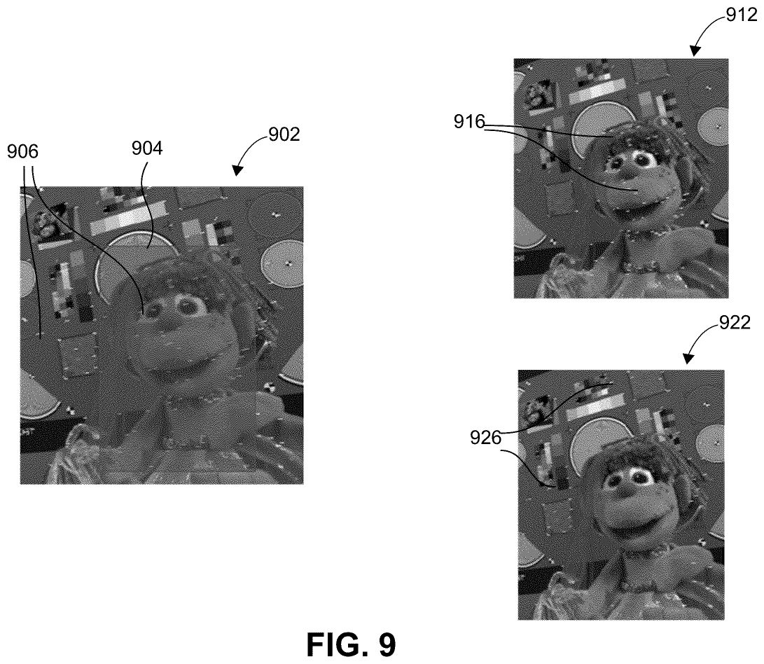

FIG. 9 includes an example image 902 including motion vectors 906 and a bounding box 904, according to various aspects of the present disclosure. Further FIG. 9 includes an example image 912 including motion vectors 916, according to various aspects of the present disclosure. Motion vectors 916 may be motion vectors of motion vectors 906 that are within bounding box 904. For example, motion vectors 916 may be in-ROI motion vectors. Further FIG. 9 includes an example image 922 including motion vectors 926, according to various aspects of the present disclosure. Motion vectors 926 may be motion vectors of motion vectors 906 that are not within bounding box 904. For example, motion vectors 926 may be out-of-ROI motion vectors.

Returning to FIG. 6, model estimator 624 may determine transformation 626 based on motion vectors 622. Transformation 626 may be, or may include, an alignment or motion model between image data 604 and image data 606. Transformation 626 may be, or may include, a projective matrix, an affine matrix, or a homography transform. For example, model estimator 624 may use random sample consensus (RANSAC) technique to generate transformation 626. As another example, model estimator 624 may use a robust-estimation technique to determine transformation 626. As yet another example, model estimator 624 may use a least-squares estimation to generate transformation 626. As yet another example, model estimator 624 may use a machine-learning model to determine transformation 626.

As an example, model estimator 624 may apply a random sample consensus (RANSAC) technique to remove outliers from motion vectors 622 to determine transformation 626. For example, model estimator 624 may being with coordinates in the input matrix (e.g., origins of vectors of motion vectors 622) and coordinates in the output matrix (e.g., end points of vectors of 622). Model estimator 624 may randomly select vectors of motion vectors 622 and calculate a homographic transform based on the randomly-selected motion vectors. Then model estimator 624 may check if the homographic transform matches motion vectors 622. If homographic transform matches motion vectors 622 for many (e.g., most of motion vectors 622), then the homographic transform is a good model. Model estimator 624 may generate and test several homographic-transform models and select the homographic transform model that best matches motion vectors 622.

Matching may be, or may include, taking x and y coordinates of the origin of the motion vectors multiplied by the transform matrix to determine coordinates of the output. If the coordinate estimated by the transform matrix matches the end points of the motion vectors, the transform matrix is good. In determining if the points match, model estimator 624 may apply a threshold, for example, a half-pixel threshold. And after applying the transform to the origins of the motion vectors, the output should match, within the threshold, the coordinates of the ends the motion vectors.

Transformer 628 may transform image data 604 based on transformation 626 to generate transformed image data 630. For example, transformer 628 may align image data 604 with image data 606 based on transformation 626. The alignment of image data 604 with image data 606 may be based on transformation 626 being based on motion vectors 610, which are defined based on differences between image data 604 and image data 606. Additionally or alternatively, transformer 628 may warp image data 604 based on transformation 626.

In the present disclosure, the term “transform” may include changing an image. In the present disclosure, aligning one image with another is an example of transforming the image. Aligning may include rotating an image or portion of an image. Additionally, warping is an example of transforming an image, warping may include stretching or compressing (in pixels space) at least a portion of an image.

In some aspects, model estimator 624 may determine transformation 626 based on the ROI, for example, based on model estimator 624 determining transformation 626 based on motion vectors 622, which are selected from among motion vectors 610 based on ROI information 618. As such, when transformer 628 transforms image data 604 based on transformation 626, transformer 628 may cause the ROI of image data 604 to align with image data 606. For example, system 600 may be designed to align an ROI of image data 604 with a corresponding region of image data 606. Peripheral regions (e.g., regions outside the ROI) may be aligned less well than the ROI is aligned. In other words, system 600 may prioritize aligning an ROI of image data 604 with a corresponding region of image data 606. The remainder of image data 604 may be aligned with image data 606, but system 600 may prioritize aligning the ROI. In some aspects, transformer 628 may align the ROI and leave the periphery of image data 604 untransformed (e.g., unaligned and/or unwarped).

Additionally or alternatively, in some aspects, model estimator 624 may determine another transformation based on the peripheral regions and transformer 628 may transform the peripheral regions of image data 604 based on the other transformation. For example, in addition to determining motion vectors 622 which are in the ROI, motion-vector selector 620 may determine motion vectors that are not in the ROI (e.g., out-of-ROI motion vectors). Model estimator 624 may determine the other transformation based on the out-of-ROI motion vectors and transformer 628 may apply the other transformation to peripheral regions of image data 604 to generate a transformed peripheral portion. In some aspects, transformer 628 may generate transformed image data 630 based on transformation 626 (based on the in-ROI motion vectors) and the other transformation (e.g., at substantially the same time). In other aspects, transformer 628 may generate an ROI portion of transformed image data 630 using transformation 626 and a peripheral portion of transformed image data 630 using the other transformation and generate transformed image data 630 by combining the ROI portion and the peripheral portion.

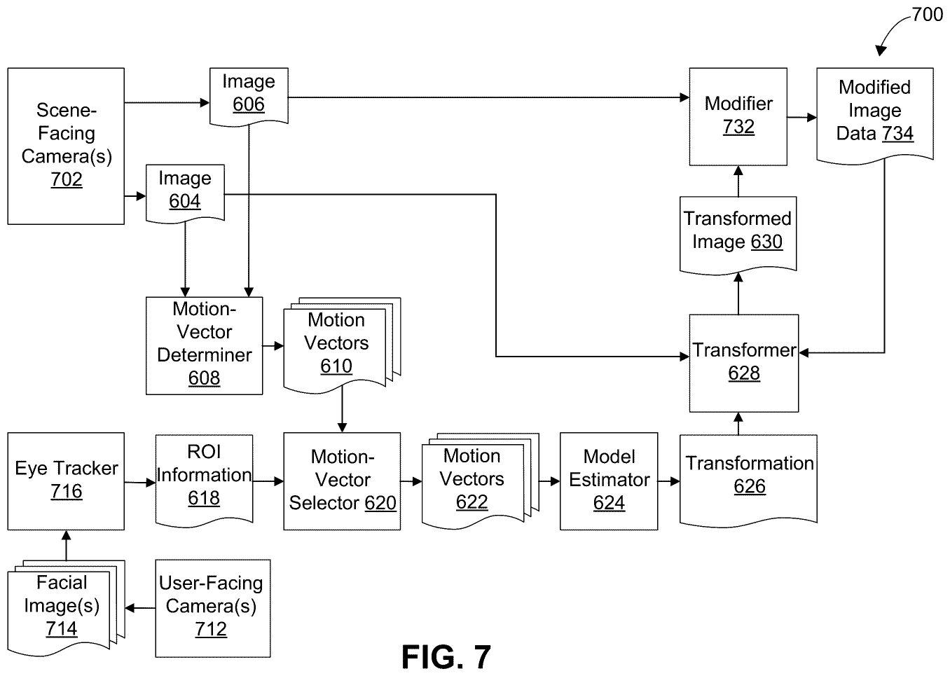

FIG. 7 is a block diagram of an example system 700 for transforming an image based on a region of interest (ROI), according to various aspects of the present disclosure. System 700 includes system 600 of FIG. 6. Further, system 700 includes additional elements. The additional elements may be optional. For example, system 700 may omit one or more of the additional elements.

For example, system 700 may include one or more scene-facing camera(s) 702. Scene-facing camera(s) 702 may be positioned on a head-mounted device (HMD), such as an extended reality (XR) HMD. Scene-facing camera(s) 702 may face away from a user (e.g., wearer) of the HMD. Scene-facing camera(s) 702 may capture image data 604 and image data 606. Scene-facing camera(s) 702 may be, or may include, one camera. In such cases, scene-facing camera(s) 702 may capture image data 604 at a first time and image data 606 at a second time. Scene-facing camera(s) 702 may be, or may include, two cameras. In such cases a first camera of scene-facing camera(s) 702 may capture image data 604 and a second camera may capture image data 606.

Additionally, system 700 may include one or more user-facing camera(s) 712. User-facing camera(s) 712 may be positioned on an HMD, for example, an XR HMD. User-facing camera(s) 712 may face toward a user of the XR HMD, more specifically, user-facing camera(s) 712 may be pointed to capture images of eyes of the user. User-facing camera(s) 712 may capture facial image(s) 714. Facial image(s) 714 may include images of eyes of the user.

System 700 may include an eye tracker 716 that may determine ROI information 618 based on facial image(s) 714. For example, eye tracker 716 may determine ROI information 618 using a glint-based gaze-tracking technique. Eye tracker 716 may convert a gaze direction into the 2D image domain of image data 604.

In some aspects, system 700 may include a modifier 732 that may modify image data 606 based on transformed image data 630 to generate modified image data 734. For example, modifier 732 may fuse (e.g., combine) transformed image data 630 with image data 606 to generate modified image data 734. For instance, modifier 732 may average transformed image data 630 with image data 606 to reduce noise in modified image data 734. As yet another example, modifier 732 may stitch transformed image data 630 together with image data 606 to generate modified image data 734. As yet another example, modifier 732 may adjust a color and/or brightness of pixels of image data 606 based on transformed image data 630 (e.g., based on the color and/or brightness of pixels of transformed image data 630). For instance, modifier 732 may take color from one image (e.g., transformed image data 630) and texture from the other image (e.g., image data 606) and combine red, green, blue (RGB) data from the one image with gray data from the other image. Such a combination may generate a modified image data 734 with better details and resolution. As yet another example, modifier 732 may add transformed image data 630 to image data 606 to increase a signal strength or exposure of modified image data 734 compared to image data 606.

In some aspects, modifier 732 may provide modified image data 734 to transformer 628. Transformer 628 may use modified image data 734 as input in order to generate the transformed image data 630 which is used by the modifier 732 when processing subsequent instances of image data 606. For example, after generating a first instance of modified image data 734 based on a first instance of image data 604 and image data 606, system 700 may obtain a second instance of image data 604. Transformer 628 may use the first instance of modified image data 734 when processing the second instance of image data 604 to generate the second instance of transformed image data 630.

As an example, modifier 732 may temporally filter an image (e.g., image data 606) based on one or more transformed images (e.g., transformed image data 630). The transformed images may be based on previously-captured, previously modified images. For instance, system 700 may implement an infinite-impulse-response (IIR) filter (e.g., using a previously-filtered frame as input to next iteration). For example, scene-facing camera(s) 702 may capture video data (including many image frames). System 700 may temporally filter the video frames to reduce noise in the video frames. Prior to temporally filtering the frames, system 700 may align the frames with each other to improve the results of the filtering. Transforming the frames (e.g., using system 600) may align the frames. In some aspects, system 700 may implement a temporal filtering technique, such as, motion-compensate temporal filtering (MCTF) or multi-frame noise reduction (MFNR).

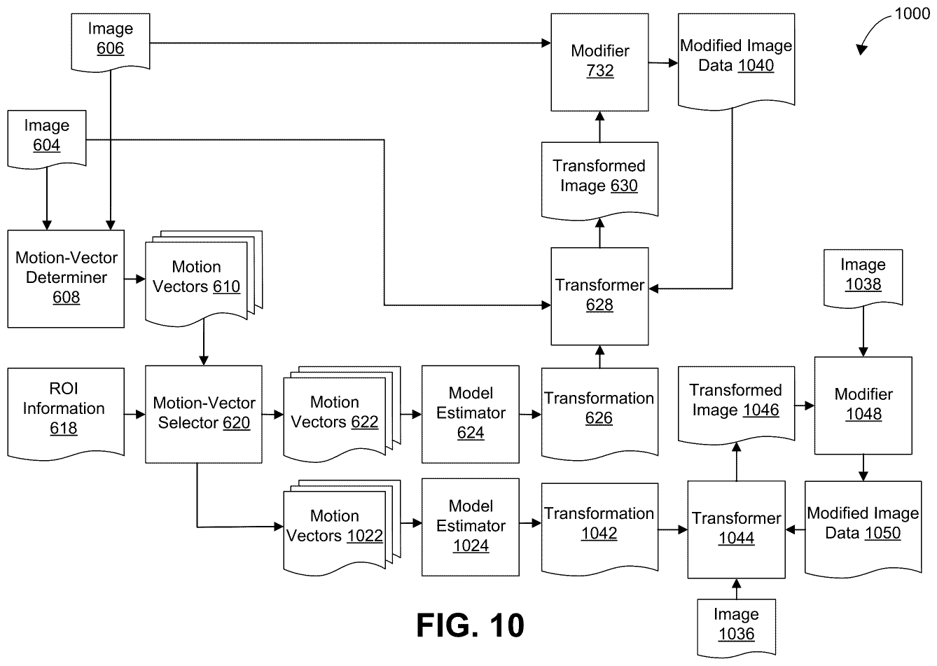

FIG. 10 is a block diagram of an example system 1000 for transforming an image based on a region of interest (ROI), according to various aspects of the present disclosure. System 1000 includes system 600 of FIG. 6 and modifier 732 of system 700 of FIG. 7. System 1000 may determine transformation 626 based on image data 604, image data 606, and ROI information 618, for example, as described above with regard to FIG. 6.

Additionally, system 1000 may obtain a lower-resolution instance of image data 604 and/or a lower-resolution instance of image data 606. For example, image data 1036 (which may be alternatively referred to as “image 1036”) may be a lower-resolution instance of image data 604 and image data 1038 (which may be alternatively referred to as “image 1038”) may be a lower-resolution instance of image data 606.

As described above with regard to FIG. 6, motion vector selector 620 may determine motion vectors 622 (which may be, or may include, ROI motion vectors) and model estimator 624 may generate a transformation 626 based on ROI motion vectors of motion vectors 622. Transformer 628 may generate transformed image data 630 including a transformed ROI of image data 604 based on image data 604 and transformation 626.

Additionally, motion vector selector 620 may determine motion vectors 1022 (which may be, or may include, non-ROI motion vectors). For example, motion vectors 622 may be ROI motion vectors of motion vectors 610 and non-ROI motion vectors 1022 may be non-ROI motion vectors of motion vectors 610 (e.g, the motion vectors of motion vectors 610 that are not ROI motion vectors). A model estimator 1024 may generate a transformation 1042 based on non-ROI motion vectors 1022. In some aspects, model estimator 1024 may be the same as, substantially similar to, perform the same operations as, or perform substantially the same similar operations as model estimator 624.

Transformation 1042 may be used to transform a non-ROI portion of image data 1036 (which may be a lower-resolution version of image data 604) based on the non-ROI motion vectors 1022. A transformer 1044 may generate a transformed peripheral portion (e.g., non-ROI portion) of image data 1036 based on transformation 1042. For example, transformer 628 may use image data 604 to generate an ROI of transformed image data 630. Further, transformer 1044 may use image data 1036 to generate a peripheral portion of transformed image data 1046.

By using image data 604 to generate an ROI of transformed image data 630 and using image data 1036 to generate a peripheral portion of transformed image data 1046, system 1000 may conserve computational resources. For example, processing and storing lower-resolution image data (e.g., of image data 1036) may be less computationally expensive than processing and storing higher-resolution image data (e.g., of image data 604). By using image data 604 to generate an ROI of transformed image data 630, system 1000 may preserve the resolution and quality of the ROI of image data 604. By using a peripheral portion of image data 1036 to generate a peripheral portion of transformed image data 1046, system 1000 may conserve computational resources.

Modifier 732 may modify an ROI portion of image data 606 based on an ROI portion of transformed image data 630 to generate modified image data 1040. Similarly modifier 1048 may modify a peripheral portion of image data 1038 based on a peripheral portion of transformed image data 1046 to generate modified image data 1050. By using an ROI portion of image data 606 to generate modified image data 1040 (which may be alternatively referred to as “modified image 1040”), modifier 732 may preserve the resolution and quality of image data 606. By using a peripheral portion of image data 1038 to generate modified image data 1050, modifier 732 may conserve computational resources.

In some aspects, modifier 732 may provide modified image data 1040 to transformer 628 and modifier 1048 may provide modified image data 1050 to transformer 1044. Transformer 628 may use modified image data 1040 as input in order to generate the transformed image data 630 which is used by the modifier 732 when processing subsequent instances of image data 604. For example, after generating a first instance of modified image data 1040 based on a first instance of image data 604 and image data 606 system 1000 may obtain a second instance of image data 604. Transformer 628 may use the first instance of modified image data 1040 when processing the second instance of image data 604 to generate the second instance of transformed image data 630. Similarly transformer 1044 may use modified image data 1050 as input in order to generate the transformed image data 1046 which is used by the modifier 1048 when processing subsequent instances of image data 1036. For example, after generating a first instance of modified image data 1050 based on a first instance of image data 1036 and image data 1038, system 1000 may obtain a second instance of image data 1036 and/or image data 1038. Transformer 1044 may use the first instance of modified image data 1050 when processing the second instance of image data 1036 to generate the second instance of transformed image data 1046.

System 1000 may combine modified image data 1040 with modified image data 1050 to generate a final image. For example, system 1000 may combine the ROI of modified image data 1040 with then non-ROI portion of modified image data 1050 to generate the final image.

In some aspects, system 1000 may include two model estimators, separate transformers, and/or modifiers. For example, model estimator 624 and model estimator 1024 may be separate and/or be implemented by separate hardware. Additionally, transformer 628 and transformer 1044 may be separate and/or be implemented by separate hardware. Additionally, modifier 732 and modifier 1048 may be separate and/or be implemented by separate hardware. In such cases, model estimator 624, transformer 628, and transformer 1044 may run in parallel with model estimator 1024, transformer 1044 and modifier 1048, for example, at substantially the same time.

In other aspects, model estimator 624 and model estimator 1024, transformer 628 and transformer 1044 and/or modifier 732 and modifier 1048 may be combined into common respective hardware or the same or may be implemented by the same respective hardware. In such cases, model estimator 624 may generate transformation 626 based on motion vectors 622 at one time and model estimator 1024 (which may be implemented in the same hardware as model estimator 624) may generate transformation 1042 based on non-ROI motion vectors 1022 at another time. Similarly transformer 628 may process image data 604 and modified image data 1040 at one time and transformer 1044 (which may be the same hardware as transformer 628) may process image data 1036 and modified image data 1050 at another time. Similarly, modifier 732 may process transformed image data 630 and image data 606 at one time and modifier 1048 (which may be the same hardware as modifier 732) may process transformed image data 1046 and image data 1038 at another time.

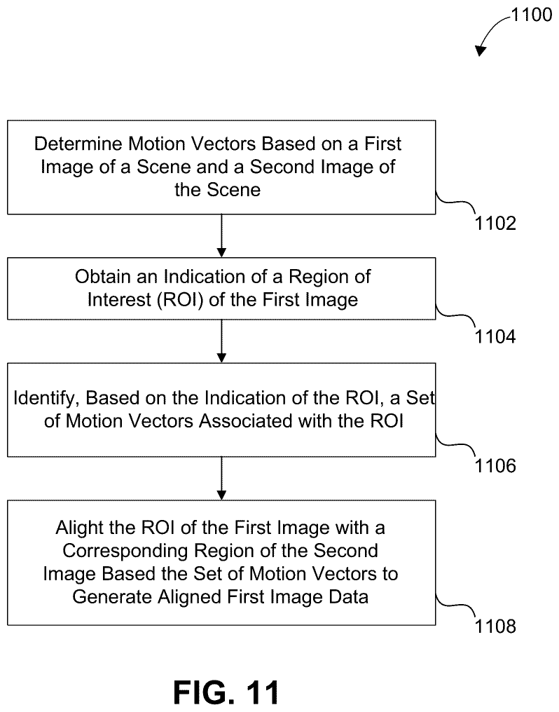

FIG. 11 is a flow diagram illustrating an example process 1100 for imaging, in accordance with aspects of the present disclosure. One or more operations of process 1100 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1100. The one or more operations of process 1100 may be implemented as software components that are executed and run on one or more processors.

At block 1102, a computing device (or one or more components thereof) may determine motion vectors based on a first image of a scene and a second image of the scene. For example, system 600 may obtain image data 604 and image data 606.

In some aspects, the first image is associated with an image sensor and a first time; and the second image is associated the image sensor and a second time. For example, image data 604 may be captured by an image sensor (e.g., one of scene-facing camera(s) 702) at a first time and image data 606 may be captured by the same image sensor at another time.

In some aspects, the first image and the second image are associated with a scene-facing camera of the HMD. For example, image data 604 and image data 606 may be captured by a scene-facing camera 702 of an HMD.

In some aspects, the first image is associated with a first image sensor; and the second image is associated with a second image sensor. For example, image data 604 may be captured by a first image sensor (e.g., one of scene-facing camera(s) 702) and image data 606 may be captured by another image sensor (e.g., another one of scene-facing camera(s) 702).

In some aspects, the first image is associated with a first scene-facing camera of the HMD; and the second image is associated with a second scene-facing camera of the HMD. For example, image data 604 may be captured by a first scene-facing camera 702 of an HMD and image data 606 may be captured by a second scene-facing camera 702 of the HMD.

At block 1104, the computing device (or one or more components thereof) may obtain an indication of a region of interest (ROI) of the first image. For example, system 600 may obtain ROI information 618.

In some aspects, the computing device (or one or more components thereof) may obtain, from a user-facing camera of a head-mounted device (HMD), an image of an eye of a user; determine a gaze of the user based on the image; and relate the gaze of the user to the first image to determine the ROI. For example, eye tracker 716 may obtain facial image(s) 714 and determine ROI information 618 based on facial image(s) 714.

In some aspects, the ROI is determined based on a computer-vision (CV) process. In some aspects, the CV process is saliency-based.

At block 1106, the computing device (or one or more components thereof) may identify, based on the indication of the ROI, a set of motion vectors associated with the ROI. For example, motion-vector selector 620 may identify motion vectors 622. Motion vectors 622 may be associated with the ROI indicated by ROI information 618. Motion vectors 622 may be a subset of motion vectors 610.

At block 1108, the computing device (or one or more components thereof) may align the ROI of the first image with a corresponding region of the second image based on the set of motion vectors to generate aligned first image data. For example, transformer 628 may align at least the ROI of image data 604 with a corresponding portion of image data 606.

In some aspects, the computing device (or one or more components thereof) may generate a motion model based on the set of motion vectors, The computing device (or one or more components thereof) may align the ROI of the first image with the corresponding region of the second image based on the motion model. For example, model estimator 624 may generate transformation 626, which may be, or may include, a motion model. Transformer 628 may transform image data 604 using transformation 626 to align image data 604 with image data 606.

In some aspects, the motion model may be, or may include, a homography transform or an affine transform. For example, transformer 628 may be, or may include, a homography transform or an affine transform.

In some aspects, to align the ROI of the first image with the corresponding region of the second image, the computing device (or one or more components thereof) may align the first image with the second image to generate the aligned first image data. For example, rather than aligning just the ROI of image data 604 with image data 606, in some aspects, transformer 628 may align all of image data 604 with image data 606. For example, model estimator 624 may generate transformation 626 such that transformer 628 aligns all of image data 604 with image data 606 by using transformation 626.

In some aspects, the set of motion vectors may be, or may include, a first set of motion vectors. The computing device (or one or more components thereof) may identify, based on the indication of the ROI, a second set of motion vectors associated with a peripheral region of the first image, wherein the peripheral region is separate from the ROI in the first image; and align the peripheral region of the first image with a corresponding peripheral region of the second image based on the second set of motion vectors to generate the aligned first image data. For example, motion-vector selector 620 may determine motion vectors 622 including ROI motion vectors and non-ROI motion vectors. Model estimator 624 may determine an instance of transformation 626 for ROIs and an instance of transformation 626 for peripheral regions. Additionally or alternatively, model estimator 624 may determine transformation 626 that may handle both ROIs and peripheral regions. Transformer 628 may apply the determined transformation 626 to transform the ROI of image data 604 and the peripheral region of image data 604 to align the ROI of image data 604 and the peripheral region of image data 604 with image data 606.

In some aspects, the computing device (or one or more components thereof) may determine a non-ROI motion model based on the second set of motion vectors and align the peripheral region of the first image with the corresponding peripheral region of the second image based on the non-ROI motion model. For example, motion-vector selector 620 may determine motion vectors 622 including ROI motion vectors and non-ROI motion vectors. Model estimator 624 may determine an instance of transformation 626 for ROIs and an instance of transformation 626 for peripheral regions. Additionally or alternatively, model estimator 624 may determine transformation 626 that may handle both ROIs and peripheral regions. Transformer 628 may apply the determined transformation 626 to transform the ROI of image data 604 and the peripheral region of image data 604 to align the ROI of image data 604 and the peripheral region of image data 604 with image data 606. In some aspects, the non-ROI motion model may be, or may include, a homography transform or an affine transform.

In some aspects, the first image may be a first instance of the first image, the first instance of the first image may have a first resolution. The set of motion vectors may be a first set of motion vectors. The computing device (or one or more components thereof) may identify, based on the indication of the ROI, a second set of motion vectors associated with a peripheral region of the first image, wherein the peripheral region is separate from the ROI; and transform a peripheral region of a second instance of the first image based on second set of motion vectors to generate the aligned first image data, wherein the second instance of the first image has a second resolution that is lower than the first resolution. For example, motion-vector selector 620 may identify ROI motion vectors and non-ROI motion vectors. Model estimator 624 may generate an instance of transformation 626 based on the ROI motion vectors and an instance of transformation 626 based on the non-ROI motion vectors. System 600 may obtain image data 604 and image data 606. Image data 604 and image data 606 may have a first resolution. System 600 may obtain image data 1036 and image data 1038. Image data 1036 and image data 1038 may have a second resolution. The second resolution may be lower than the first resolution. Transformer 628 may align the ROI of image data 604 with image data 606 using the instance of transformation 626 based on the ROI motion vectors. Additionally, transformer 628 may align the non-ROI of image data 1036 with image data 1038 using the instance of transformation 626 based on the non-ROI motion vectors. System 600 may combine the aligned image data 604 and the aligned image data 1036.

In some aspects, the computing device (or one or more components thereof) may determine a non-ROI motion model based on the second set of motion vectors; and align the peripheral region of the first image with the corresponding peripheral region of the second image based on the non-ROI motion model. For example, motion-vector selector 620 may identify ROI motion vectors and non-ROI motion vectors. Model estimator 624 may generate an instance of transformation 626 based on the ROI motion vectors and an instance of transformation 626 based on the non-ROI motion vectors. System 600 may obtain image data 604 and image data 606. Image data 604 and image data 606 may have a first resolution. System 600 may obtain image data 1036 and image data 1038. Image data 1036 and image data 1038 may have a second resolution. The second resolution may be lower than the first resolution. Transformer 628 may align the ROI of image data 604 with image data 606 using the instance of transformation 626 based on the ROI motion vectors. Additionally, transformer 628 may align the non-ROI of image data 1036 with image data 1038 using the instance of transformation 626 based on the non-ROI motion vectors. System 600 may combine the aligned image data 604 and the aligned image data 1036. In some aspects, the non-ROI motion model may be, or may include, a homography transform or an affine transform.

In some aspects, the computing device (or one or more components thereof) may warp the ROI of the first image to generate warped first image data. For example, transformer 628 may warp image data 604 to generate transformed image data 630. For example, model estimator 624 may generate transformation 626 to warp to image data 604. Warping image data 604 may include stretching or compressing, in pixel space, at least a portion of image data 604.

In some aspects, the computing device (or one or more components thereof) may modify the second image based on the aligned first image data. For example, modifier 732 may modify image data 606 based on transformed image data 630 to generate modified image data 734.

In some aspects, to modify the second image based on the aligned first image data, the computing device (or one or more components thereof) may fuse the aligned first image data with the second image. For example, modifier 732 may fuse image data 606 with transformed image data 630 to generate modified image data 734.

In some aspects, to modify the second image based on the aligned first image data, the computing device (or one or more components thereof) may denoise the second image based on the aligned first image data. For example, modifier 732 may denoise image data 606 based on transformed image data 630 to generate modified image data 734.

In some aspects, to modify the second image based on the aligned first image data, the computing device (or one or more components thereof) may stitch the second image and the aligned first image data. For example, modifier 732 may stitch image data 606 and transformed image data 630 to generate modified image data 734.

In some aspects, to modify the second image based on the aligned first image data, the computing device (or one or more components thereof) may adjust at least one of: color or intensity of pixels of the second image based on corresponding pixels of the aligned first image data. For example, modifier 732 may adjust color and/or intensity of pixels of image data 606 based on transformed image data 630 to generate modified image data 734.

In some aspects, to modify the second image based on the aligned first image data, the computing device (or one or more components thereof) may filter the second image based on the aligned first image data according to at least one of: a temporal-filtering process, a motion-compensated temporal filter (MCTF) process, or a multi-frame noise reduction (MFNR) process. For example, modifier 732 may filter image data 606 based on transformed image data 630 according to an MCTF of MFNR process to generate modified image data 734.

In some aspects, the computing device (or one or more components thereof) may modify the second image based on the aligned first image data; and display the modified second image at a display of the HMD. For example, system 700 may cause modified image data 734 to be displayed at a display of an HMD.

In some aspects, the first image and the second image are associated with at least one scene-facing camera of a head-mounted device (HMD). The ROI is based on a gaze of a user of the HMD. The gaze is determined based on an image of an eye of the user associated with at least one user-facing camera of the HMD. The computing device (or one or more components thereof) may modify the second image based on the aligned first image data; and display the modified second image at a display of the HMD. For example, user-facing camera(s) 712 of an HMD may capture facial image(s) 714. Eye tracker 716 may determine ROI information 618 based on facial image(s) 714. Scene facing camera(s) 702 of the HMD may capture image data 604 and image data 606. Modifier 732 may modify image data 606 based on transformed image data 630 to generate modified image data 734. System 700 may cause modified image data 734 to be displayed at a display of the HMD.

In some examples, as noted previously, the methods described herein (e.g., process 1100 of FIG. 11, and/or other methods described herein) can be performed, in whole or in part, by a computing device or apparatus. In one example, one or more of the methods can be performed by system 600 of FIG. 6, system 700 of FIG. 7, system 1000 of FIG. 10, or by another system or device. In another example, one or more of the methods (e.g., process 1100, and/or other methods described herein) can be performed, in whole or in part, by the computing-device architecture 1400 shown in FIG. 14. For instance, a computing device with the computing-device architecture 1400 shown in FIG. 14 can include, or be included in, the components of the system 600, system 700, system 1000, and can implement the operations of process 1100, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1100, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1100, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

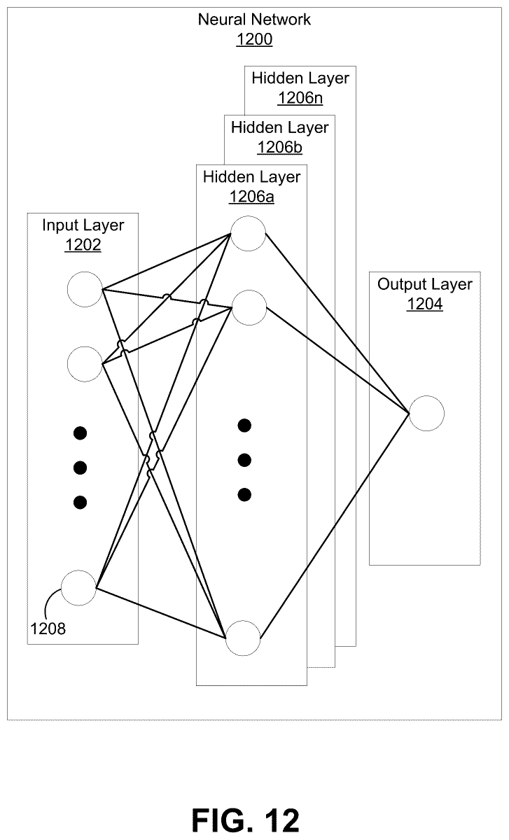

FIG. 12 is an illustrative example of a neural network 1200 (e.g., a deep-learning neural network) that can be used to implement machine-learning based feature identification, feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1200 may be an example of, or can implement, motion-vector determiner 608 of FIG. 6, motion-vector selector 620 of FIG. 6, model estimator 624 of FIG. 6, transformer 628 of FIG. 6, eye tracker 716 of FIG. 7, and/or modifier 732 of FIG. 7.

An input layer 1202 includes input data. In one illustrative example, input layer 1202 can include data representing image data 604 of FIG. 6, image data 606 of FIG. 6, motion vectors 610 of FIG. 6, ROI information 618 of FIG. 6, motion vectors 622 of FIG. 6, transformation 626 of FIG. 6, transformed image data 630 of FIG. 6, and/or facial image(s) 714 of FIG. 7. Neural network 1200 includes multiple hidden layers, for example, hidden layers 1206a, 1206b, through 1206n. The hidden layers 1206a, 1206b, through hidden layer 1206n include “n” number of hidden layers, where “n” is an integer greater than or equal to one. The number of hidden layers can be made to include as many layers as needed for the given application. Neural network 1200 further includes an output layer 1204 that provides an output resulting from the processing performed by the hidden layers 1206a, 1206b, through 1206n. In one illustrative example, output layer 1204 can provide motion vectors 610, motion vectors 622, transformation 626, transformed image data 630, ROI information 618, and/or modified image data 734 of FIG. 7.

Neural network 1200 may be, or may include, a multi-layer neural network of interconnected nodes. Each node can represent a piece of information. Information associated with the nodes is shared among the different layers and each layer retains information as information is processed. In some cases, neural network 1200 can include a feed-forward network, in which case there are no feedback connections where outputs of the network are fed back into itself. In some cases, neural network 1200 can include a recurrent neural network, which can have loops that allow information to be carried across nodes while reading in input.

Information can be exchanged between nodes through node-to-node interconnections between the various layers. Nodes of input layer 1202 can activate a set of nodes in the first hidden layer 1206a. For example, as shown, each of the input nodes of input layer 1202 is connected to each of the nodes of the first hidden layer 1206a. The nodes of first hidden layer 1206a can transform the information of each input node by applying activation functions to the input node information. The information derived from the transformation can then be passed to and can activate the nodes of the next hidden layer 1206b, which can perform their own designated functions. Example functions include convolutional, up-sampling, data transformation, and/or any other suitable functions. The output of the hidden layer 1206b can then activate nodes of the next hidden layer, and so on. The output of the last hidden layer 1206n can activate one or more nodes of the output layer 1204, at which an output is provided. In some cases, while nodes (e.g., node 1208) in neural network 1200 are shown as having multiple output lines, a node has a single output and all lines shown as being output from a node represent the same output value.

In some cases, each node or interconnection between nodes can have a weight that is a set of parameters derived from the training of neural network 1200. Once neural network 1200 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1200 to be adaptive to inputs and able to learn as more and more data is processed.

Neural network 1200 may be pre-trained to process the features from the data in the input layer 1202 using the different hidden layers 1206a, 1206b, through 1206n in order to provide the output through the output layer 1204. In an example in which neural network 1200 is used to identify features in images, neural network 1200 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0010000000].

In some cases, neural network 1200 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1200 is trained well enough so that the weights of the layers are accurately tuned.

For the example of identifying objects in images, the forward pass can include passing a training image through neural network 1200. The weights are initially randomized before neural network 1200 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1200, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1200 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = \sum \frac{1}{2} {( target - output )}^{2} .$$

The loss (or error) will be high for the first training images since the actual values will be much different than the predicted output. The goal of training is to minimize the amount of loss so that the predicted output is the same as the training label. Neural network 1200 can perform a backward pass by determining which inputs (weights) most contributed to the loss of the network and can adjust the weights so that the loss decreases and is eventually minimized. A derivative of the loss with respect to the weights (denoted as dLldW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and n denotes a learning rate. The learning rate can be set to any suitable value, with a high learning rate including larger weight updates and a lower value indicating smaller weight updates.

Neural network 1200 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1200 can include any other deep network other than a CNN, such as an autoencoder, a deep belief nets (DBNs), a Recurrent Neural Networks (RNNs), among others.

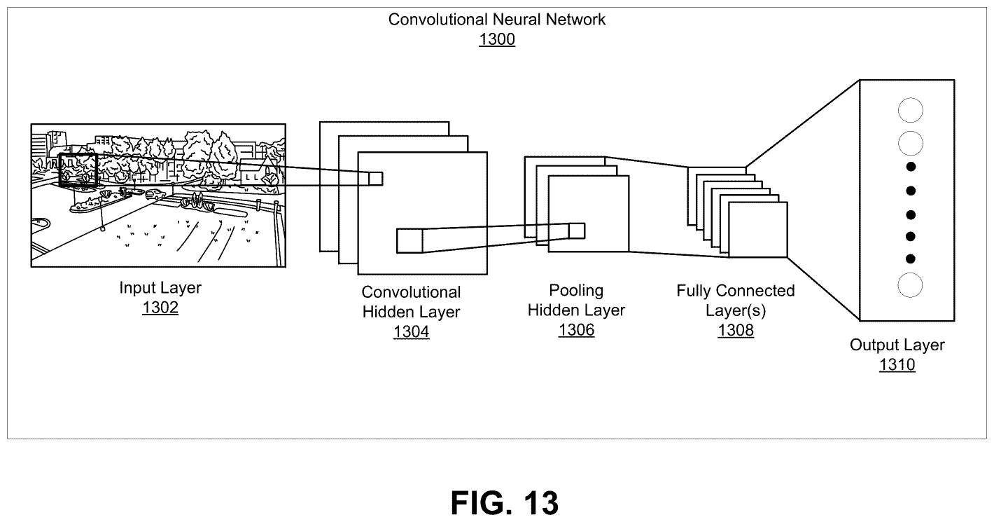

FIG. 13 is an illustrative example of a convolutional neural network (CNN) 1300. The input layer 1302 of the CNN 1300 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1304, an optional non-linear activation layer, a pooling hidden layer 1306, and fully connected layer 1308 (which fully connected layer 1308 can be hidden) to get an output at the output layer 1310. While only one of each hidden layer is shown in FIG. 13, one of ordinary skill will appreciate that multiple convolutional hidden layers, non-linear layers, pooling hidden layers, and/or fully connected layers can be included in the CNN 1300. As previously described, the output can indicate a single class of an object or can include a probability of classes that best describe the object in the image.

The first layer of the CNN 1300 can be the convolutional hidden layer 1304. The convolutional hidden layer 1304 can analyze image data of the input layer 1302. Each node of the convolutional hidden layer 1304 is connected to a region of nodes (pixels) of the input image called a receptive field. The convolutional hidden layer 1304 can be considered as one or more filters (each filter corresponding to a different activation or feature map), with each convolutional iteration of a filter being a node or neuron of the convolutional hidden layer 1304. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1304. Each connection between a node and a receptive field for that node learns a weight and, in some cases, an overall bias such that each node learns to analyze its particular local receptive field in the input image. Each node of the convolutional hidden layer 1304 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1304 is due to each node of the convolutional layer being applied to its corresponding receptive field. For example, a filter of the convolutional hidden layer 1304 can begin in the top-left corner of the input image array and can convolve around the input image. As noted above, each convolutional iteration of the filter can be considered a node or neuron of the convolutional hidden layer 1304. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1304. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1304.

The mapping from the input layer to the convolutional hidden layer 1304 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1304 can include several activation maps in order to identify multiple features in an image. The example shown in FIG. 13 includes three activation maps. Using three activation maps, the convolutional hidden layer 1304 can detect three different kinds of features, with each feature being detectable across the entire image.

In some examples, a non-linear hidden layer can be applied after the convolutional hidden layer 1304. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 1300 without affecting the receptive fields of the convolutional hidden layer 1304.

The pooling hidden layer 1306 can be applied after the convolutional hidden layer 1304 (and after the non-linear hidden layer when used). The pooling hidden layer 1306 is used to simplify the information in the output from the convolutional hidden layer 1304. For example, the pooling hidden layer 1306 can take each activation map output from the convolutional hidden layer 1304 and generates a condensed activation map (or feature map) using a pooling function. Max-pooling is one example of a function performed by a pooling hidden layer. Other forms of pooling functions be used by the pooling hidden layer 1306, such as average pooling, L2-norm pooling, or other suitable pooling functions. A pooling function (e.g., a max-pooling filter, an L2-norm filter, or other suitable pooling filter) is applied to each activation map included in the convolutional hidden layer 1304. In the example shown in FIG. 13, three pooling filters are used for the three activation maps in the convolutional hidden layer 1304.

In some examples, max-pooling can be used by applying a max-pooling filter (e.g., having a size of 2×2) with a stride (e.g., equal to a dimension of the filter, such as a stride of 2) to an activation map output from the convolutional hidden layer 1304. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1304 having a dimension of 24×24 nodes, the output from the pooling hidden layer 1306 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1300.

The final layer of connections in the network is a fully-connected layer that connects every node from the pooling hidden layer 1306 to every one of the output nodes in the output layer 1310. Using the example above, the input layer includes 28×28 nodes encoding the pixel intensities of the input image, the convolutional hidden layer 1304 includes 3×24×24 hidden feature nodes based on application of a 5×5 local receptive field (for the filters) to three activation maps, and the pooling hidden layer 1306 includes a layer of 3×12×12 hidden feature nodes based on application of max-pooling filter to 2×2 regions across each of the three feature maps. Extending this example, the output layer 1310 can include ten output nodes. In such an example, every node of the 3×12×12 pooling hidden layer 1306 is connected to every node of the output layer 1310.

The fully connected layer 1308 can obtain the output of the previous pooling hidden layer 1306 (which should represent the activation maps of high-level features) and determines the features that most correlate to a particular class. For example, the fully connected layer 1308 can determine the high-level features that most strongly correlate to a particular class and can include weights (nodes) for the high-level features. A product can be computed between the weights of the fully connected layer 1308 and the pooling hidden layer 1306 to obtain probabilities for the different classes. For example, if the CNN 1300 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1310 can include an M-dimensional vector (in the prior example, M=10). M indicates the number of classes that the CNN 1300 has to choose from when classifying the object in the image. Other example outputs can also be provided. Each number in the M-dimensional vector can represent the probability the object is of a certain class. In one illustrative example, if a 10-dimensional output vector represents ten different classes of objects is [00 0.05 0.800.150000], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 14 illustrates an example computing-device architecture 1400 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1400 may include, implement, or be included in any or all of system 600 of FIG. 6, system 700 of FIG. 7, system 1000 of FIG. 10, and/or other devices, modules, or systems described herein. Additionally or alternatively, computing-device architecture 1400 may be configured to perform process 1100, and/or other process described herein.

The components of computing-device architecture 1400 are shown in electrical communication with each other using connection 1412, such as a bus. The example computing-device architecture 1400 includes a processing unit (CPU or processor) 1402 and computing device connection 1412 that couples various computing device components including computing device memory 1410, such as read only memory (ROM) 1408 and random-access memory (RAM) 1406, to processor 1402.

Computing-device architecture 1400 can include a cache of high-speed memory connected directly with, in close proximity to, or integrated as part of processor 1402. Computing-device architecture 1400 can copy data from memory 1410 and/or the storage device 1414 to cache 1404 for quick access by processor 1402. In this way, the cache can provide a performance boost that avoids processor 1402 delays while waiting for data. These and other modules can control or be configured to control processor 1402 to perform various actions. Other computing device memory 1410 may be available for use as well. Memory 1410 can include multiple different types of memory with different performance characteristics. Processor 1402 can include any general-purpose processor and a hardware or software service, such as service 1 1416, service 2 1418, and service 3 1420 stored in storage device 1414, configured to control processor 1402 as well as a special-purpose processor where software instructions are incorporated into the processor design. Processor 1402 may be a self-contained system, containing multiple cores or processors, a bus, memory controller, cache, etc. A multi-core processor may be symmetric or asymmetric.

To enable user interaction with the computing-device architecture 1400, input device 1422 can represent any number of input mechanisms, such as a microphone for speech, a touch-sensitive screen for gesture or graphical input, keyboard, mouse, motion input, speech and so forth. Output device 1424 can also be one or more of a number of output mechanisms known to those of skill in the art, such as a display, projector, television, speaker device, etc. In some instances, multimodal computing devices can enable a user to provide multiple types of input to communicate with computing-device architecture 1400. Communication interface 1426 can generally govern and manage the user input and computing device output. There is no restriction on operating on any particular hardware arrangement and therefore the basic features here may easily be substituted for improved hardware or firmware arrangements as they are developed.

Storage device 1414 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1406, read only memory (ROM) 1408, and hybrids thereof. Storage device 1414 can include services 1416, 1418, and 1420 for controlling processor 1402. Other hardware or software modules are contemplated. Storage device 1414 can be connected to the computing device connection 1412. In one aspect, a hardware module that performs a particular function can include the software component stored in a computer-readable medium in connection with the necessary hardware components, such as processor 1402, connection 1412, output device 1424, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“s”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for imaging, the apparatus comprising: at least one memory; and at least one processor coupled to the at least one memory and configured to: determine motion vectors based on a first image of a scene and a second image of the scene; obtain an indication of a region of interest (ROI) of the first image; identify, based on the indication of the ROI, a set of motion vectors associated with the ROI; and align the ROI of the first image with a corresponding region of the second image based on the set of motion vectors to generate aligned first image data.
Aspect 2. The apparatus of aspect 1, wherein the at least one processor is configured to: generate a motion model based on the set of motion vectors, and align the ROI of the first image with the corresponding region of the second image based on the motion model.
Aspect 3. The apparatus of aspect 2, wherein the motion model comprises a homography transform or an affine transform.
Aspect 4. The apparatus of any one of aspects 1 to 3, wherein to align the ROI of the first image with the corresponding region of the second image, the at least one processor is configured to warp the ROI of the first image.
Aspect 5. The apparatus of any one of aspects 1 to 4, wherein, to align the ROI of the first image with the corresponding region of the second image, the at least one processor is configured to align the first image with the second image to generate the aligned first image data.
Aspect 6. The apparatus of any one of aspects 1 to 5, wherein the set of motion vectors comprises a first set of motion vectors, wherein the at least one processor is configured to: identify, based on the indication of the ROI, a second set of motion vectors associated with a peripheral region of the first image, wherein the peripheral region is separate from the ROI in the first image; and align the peripheral region of the first image with a corresponding peripheral region of the second image based on the second set of motion vectors to generate the aligned first image data.
Aspect 7. The apparatus of aspect 6, wherein the at least one processor is configured to: determine a non-ROI motion model based on the second set of motion vectors; and align the peripheral region of the first image with a corresponding peripheral region of the second image based on the non-ROI motion model.
Aspect 8. The apparatus of aspect 7, wherein the non-ROI motion model comprises a homography transform or an affine transform.
Aspect 9. The apparatus of any one of aspects 1 to 8, wherein the first image comprises a first instance of the first image, the first instance of the first image has a first resolution, and the set of motion vectors comprises a first set of motion vectors, wherein the at least one processor is configured to: identify, based on the indication of the ROI, a second set of motion vectors associated with a peripheral region of the first image, wherein the peripheral region is separate from the ROI; and align a peripheral region of a second instance of the first image with a corresponding peripheral region of the second images based on the second set of motion vectors to generate the aligned first image data, wherein the second instance of the first image has a second resolution that is lower than the first resolution.
Aspect 10. The apparatus of aspect 9, wherein the at least one processor is configured to: determine a non-ROI motion model based on the second set of motion vectors; and align the peripheral region of the first image with the corresponding peripheral region of the second image based on the non-ROI motion model.
Aspect 11. The apparatus of aspect 10, wherein the non-ROI motion model comprises a homography transform or an affine transform.
Aspect 12. The apparatus of any one of aspects 1 to 11, wherein the at least one processor is configured to modify the second image based on the aligned first image data.
Aspect 13. The apparatus of aspect 12, wherein, to modify the second image based on the aligned first image data, the at least one processor is configured to fuse the aligned first image data with the second image.
Aspect 14. The apparatus of aspect 12, wherein, to modify the second image based on the aligned first image data, the at least one processor is configured to denoise the second image based on the aligned first image data.
Aspect 15. The apparatus of aspect 12, wherein, to modify the second image based on the aligned first image data, the at least one processor is configured to stitch the second image and the aligned first image data.
Aspect 16. The apparatus of aspect 12, wherein, to modify the second image based on the aligned first image data, the at least one processor is configured to adjust at least one of: color or intensity of pixels of the second image based on corresponding pixels of the aligned first image data.
Aspect 17. The apparatus of aspect 12, wherein, to modify the second image based on the aligned first image data, the at least one processor is configured to filter the second image based on the aligned first image data according to at least one of: a temporal-filtering process, a motion-compensated temporal filter (MCTF) process, or a multi-frame noise reduction (MFNR) process.
Aspect 18. The apparatus of any one of aspects 1 to 17, wherein: the first image is associated with an image sensor and a first time; and the second image is associated the image sensor and a second time.
Aspect 19. The apparatus of any one of aspects 1 to 18, wherein: the first image is associated with a first image sensor; and the second image is associated with a second image sensor.
Aspect 20. The apparatus of any one of aspects 1 to 19, wherein the at least one processor is configured to: obtain, from a user-facing camera of a head-mounted device (HMD), an image of an eye of a user; determine a gaze of the user based on the image; and relate the gaze of the user to the first image to determine the ROI.
Aspect 21. The apparatus of aspect 20 wherein the at least one processor is configured to: modify the second image based on the aligned first image data; and display the modified second image at a display of the HMD.
Aspect 22. The apparatus of any one of aspects 20 or 21, wherein the first image and the second image are associated with a scene-facing camera of the HMD.
Aspect 23. The apparatus of any one of aspects 20 or 21, wherein: the first image is associated with a first scene-facing camera of the HMD; and the second image is associated with a second scene-facing camera of the HMD.
Aspect 24. The apparatus of any one of aspects 1 to 23, wherein the first image and the second image are associated with at least one scene-facing camera of a head-mounted device (HMD), wherein the ROI is based on a gaze of a user of the HMD, and wherein the gaze is determined based on an image of an eye of the user associated with at least one user-facing camera of the HMD, the at least one processor is configured to: modify the second image based on the aligned first image data; and display the modified second image at a display of the HMD.
Aspect 25. The apparatus of any one of aspects 1 to 24, wherein the ROI is determined based on a computer-vision (CV) process.
Aspect 26. The apparatus of aspect 25, where the CV process is saliency-based.
Aspect 27. A method for imaging, the method comprising: determining motion vectors based on a first image of a scene and a second image of the scene; obtaining an indication of a region of interest (ROI) of the first image; identifying, based on the indication of the ROI, a set of motion vectors associated with the ROI; and aligning the ROI of the first image with a corresponding region of the second image based on the set of motion vectors to generate aligned first image data.
Aspect 28. The method of aspect 27, further comprising generating a motion model based on the set of motion vectors, wherein the ROI of the first image is aligned with the corresponding region of the second image based on the motion model.
Aspect 29. The method of aspect 28, wherein the motion model comprises a homography transform or an affine transform.
Aspect 30. The method of any one of aspects 27 to 29, wherein aligning the ROI of the first image with the corresponding region of the second image comprises warping the ROI of the first image to generate the aligned first image data.
Aspect 31. The method of any one of aspects 27 to 30, wherein aligning the ROI of the first image with the corresponding region of the second image comprises aligning the first image with the second image to generate the aligned first image data.
Aspect 32. The method of any one of aspects 27 to 31, wherein the set of motion vectors comprises a first set of motion vectors, the method further comprising: identifying, based on the indication of the ROI, a second set of motion vectors associated with a peripheral region of the first image, wherein the peripheral region is separate from the ROI in the first image; and aligning the peripheral region of the first image with a corresponding peripheral region of the second image based on the second set of motion vectors to generate the aligned first image data.
Aspect 33. The method of aspect 32, further comprising determining a non-ROI motion model based on the second set of motion vectors, wherein the peripheral region of the first image is aligned with the corresponding peripheral region of the second image based on the non-ROI motion model.
Aspect 34. The method of aspect 33, wherein the motion model comprises a homography transform or an affine transform.
Aspect 35. The method of any one of aspects 27 to 34, wherein the first image comprises a first instance of the first image, the first instance of the first image has a first resolution, and the set of motion vectors comprises a first set of motion vectors, the method further comprising: identifying, based on the indication of the ROI, a second set of motion vectors associated with a peripheral region of the first image, wherein the peripheral region is separate from the ROI; and aligning a peripheral region of a second instance of the first image with a corresponding peripheral region of the second images based on the second set of motion vectors to generate the aligned first image data, wherein the second instance of the first image has a second resolution that is lower than the first resolution.
Aspect 36. The method of aspect 35, further comprising determining a non-ROI motion model based on the second set of motion vectors, wherein the peripheral region of the first image is aligned with the corresponding peripheral region of the second image based on the non-ROI motion model.
Aspect 37. The method of aspect 36, wherein the motion model comprises a homography transform or an affine transform.
Aspect 38. The method of any one of aspects 27 to 37, further comprising modifying the second image based on the aligned first image data.
Aspect 39. The method of aspect 38, wherein modifying the second image based on the aligned first image data comprises fusing the aligned first image data with the second image.
Aspect 40. The method of aspect 38, wherein modifying the second image based on the aligned first image data comprises denoising the second image based on the aligned first image data.
Aspect 41. The method of aspect 38, wherein modifying the second image based on the aligned first image data comprises stitching the second image and the aligned first image data.
Aspect 42. The method of aspect 38, wherein modifying the second image based on the aligned first image data comprises adjusting at least one of: color or intensity of pixels of the second image based on corresponding pixels of the aligned first image data.
Aspect 43. The method of aspect 38, wherein modifying the second image based on the aligned first image data comprises filtering the second image based on the aligned first image data according to at least one of: a temporal-filtering process, a motion-compensated temporal filter (MCTF) process, or a multi-frame noise reduction (MFNR) process.
Aspect 44. The method of any one of aspects 27 to 43, wherein: the first image is associated with an image sensor and a first time; and the second image is associated the image sensor and a second time.
Aspect 45. The method of any one of aspects 27 to 43, wherein: the first image is associated with a first image sensor; and the second image is associated with a second image sensor.
Aspect 46. The method of any one of aspects 27 to 45, further comprising: obtaining, from a user-facing camera of a head-mounted device (HMD), an image of an eye of a user; determining a gaze of the user based on the image; and relating the gaze of the user to the first image to determine the ROI.
Aspect 47. The method of aspect 46 further comprising: modifying the second image based on the aligned first image data; and displaying the modified second image at a display of the HMD.
Aspect 48. The method of any one of aspects 46 or 47, wherein the first image and the second image are associated with a scene-facing camera of the HMD.
Aspect 49. The method of any one of aspects 46 or 46, wherein: the first image is associated with a first scene-facing camera of the HMD; and the second image is associated with a second scene-facing camera of the HMD.
Aspect 50. The method of any one of aspects 27 to 49, wherein the first image and the second image are associated with at least one scene-facing camera of a head-mounted device (HMD), wherein the ROI is based on a gaze of a user of the HMD, and wherein the gaze is determined based on an image of an eye of the user associated with at least one user-facing camera of the HMD, the method further comprising: modifying the second image based on the aligned first image data; and displaying the modified second image at a display of the HMD.
Aspect 51. The method of any one of aspects 27 to 50, wherein the ROI is determined based on a computer-vision (CV) process.
Aspect 52. The method of aspect 51, where the CV process is saliency-based.
Aspect 53. A non-transitory computer-readable storage medium having stored thereon instructions that, when executed by at least one processor, cause the at least one processor to perform operations according to any of aspects 27 to 52.
Aspect 54. A non-transitory computer-readable storage medium having stored thereon instructions that, when executed by at least one processor, cause the at least one processor to perform operations according to any of aspects 27 to 52.

What is claimed is:

1. An apparatus for imaging, the apparatus comprising:
at least one memory; and
at least one processor coupled to the at least one memory and configured to:
determine motion vectors based on a first image of a scene and a second image of the scene;
obtain an indication of a region of interest (ROI) of the first image;
identify, based on the indication of the ROI, a set of motion vectors associated with the ROI; and
align the ROI of the first image with a corresponding region of the second image based on the set of motion vectors to generate aligned first image data.

2. The apparatus of claim 1, wherein the at least one processor is configured to:
generate a motion model based on the set of motion vectors, and
align the ROI of the first image with the corresponding region of the second image based on the motion model.

3. The apparatus of claim 1, wherein to align the ROI of the first image with the corresponding region of the second image, the at least one processor is configured to warp the ROI of the first image.

4. The apparatus of claim 1, wherein, to align the ROI of the first image with the corresponding region of the second image, the at least one processor is configured to align the first image with the second image to generate the aligned first image data.

5. The apparatus of claim 1, wherein the set of motion vectors comprises a first set of motion vectors, wherein the at least one processor is configured to:
identify, based on the indication of the ROI, a second set of motion vectors associated with a peripheral region of the first image, wherein the peripheral region is separate from the ROI in the first image; and
align the peripheral region of the first image with a corresponding peripheral region of the second image based on the second set of motion vectors to generate the aligned first image data.

6. The apparatus of claim 1, wherein the first image comprises a first instance of the first image, the first instance of the first image has a first resolution, and the set of motion vectors comprises a first set of motion vectors, wherein the at least one processor is configured to:
identify, based on the indication of the ROI, a second set of motion vectors associated with a peripheral region of the first image, wherein the peripheral region is separate from the ROI; and
align a peripheral region of a second instance of the first image with a corresponding peripheral region of the second images based on the second set of motion vectors to generate the aligned first image data, wherein the second instance of the first image has a second resolution that is lower than the first resolution.

7. The apparatus of claim 1, wherein the at least one processor is configured to modify the second image based on the aligned first image data.

8. The apparatus of claim 7, wherein, to modify the second image based on the aligned first image data, the at least one processor is configured to fuse the aligned first image data with the second image.

9. The apparatus of claim 7, wherein, to modify the second image based on the aligned first image data, the at least one processor is configured to denoise the second image based on the aligned first image data.

10. The apparatus of claim 7, wherein, to modify the second image based on the aligned first image data, the at least one processor is configured to stitch the second image and the aligned first image data.

11. The apparatus of claim 7, wherein, to modify the second image based on the aligned first image data, the at least one processor is configured to adjust at least one of: color or intensity of pixels of the second image based on corresponding pixels of the aligned first image data.

12. The apparatus of claim 7, wherein, to modify the second image based on the aligned first image data, the at least one processor is configured to filter the second image based on the aligned first image data according to at least one of: a temporal-filtering process, a motion-compensated temporal filter (MCTF) process, or a multi-frame noise reduction (MFNR) process.

13. The apparatus of claim 1, wherein:
the first image is associated with an image sensor and a first time; and
the second image is associated the image sensor and a second time.

14. The apparatus of claim 1, wherein:
the first image is associated with a first image sensor; and
the second image is associated with a second image sensor.

15. The apparatus of claim 1, wherein the at least one processor is configured to:
obtain, from a user-facing camera of a head-mounted device (HMD), an image of an eye of a user;
determine a gaze of the user based on the image; and
relate the gaze of the user to the first image to determine the ROI.

16. The apparatus of claim 15 wherein the at least one processor is configured to:
modify the second image based on the aligned first image data; and
display the modified second image at a display of the HMD.

17. The apparatus of claim 1, wherein the first image and the second image are associated with at least one scene-facing camera of a head-mounted device (HMD), wherein the ROI is based on a gaze of a user of the HMD, and wherein the gaze is determined based on an image of an eye of the user associated with at least one user-facing camera of the HMD, the at least one processor is configured to:
modify the second image based on the aligned first image data; and
display the modified second image at a display of the HMD.

18. The apparatus of claim 1, wherein the ROI is determined based on a computer-vision (CV) process.

19. The apparatus of claim 18, where the CV process is saliency-based.

20. A method for imaging, the method comprising:
determining motion vectors based on a first image of a scene and a second image of the scene;
obtaining an indication of a region of interest (ROI) of the first image;
identifying, based on the indication of the ROI, a set of motion vectors associated with the ROI; and
aligning the ROI of the first image with a corresponding region of the second image based on the set of motion vectors to generate aligned first image data.
